(19) United States
(12) Patent Application Publication
(10) Pub. No.: US 2026/0126651 A1
(43) Pub. Date: May 7, 2026

(54) POLARIZATION INSENSITIVE DIFFRACTION GRATING AND DISPLAY INCLUDING THE SAME

(71) Applicant: Magic Leap, Inc., Plantation, FL (US)

(72) Inventors: Mohammadsadegh FARAJI-DANA, Sunnyvale, CA (US); Robert D. Tekolste, Boulder, CO (US); Chinmay KHANDEKAR, Sunnyvale, CA (US); Liyi Hsu, Plantation, FL (US); Vikramjit SINGH, Pflugerville, TX (US); Mauro MELLI, San Leandro, CA (US); Victor Kai Liu, Mountain View, CA (US)

(21) Appl. No.: 19/117,210

(22) PCT Filed: Nov. 7, 2023
(86) PCT No.: PCT/US2023/079003

§ 371 Date: Mar. 31, 2025

Related U.S. Application Data
(60) Provisional application No. 63/423,286, filed on Nov. 7, 2022.

(51) Int. Cl. G02B 27/01

(52) U.S. Cl. CPC G02B 27/0172

(57) ABSTRACT

Polarization insensitive gratings and displays including the same are disclosed.

### CROSS-REFERENCE TO RELATED APPLICATIONS

This application claims the benefit of priority to Provisional Application No. 63/423,286, titled “POLARIZATION INSENSITIVE DIFFRACTION GRATING AND DISPLAY INCLUDING THE SAME,” filed on Nov. 7, 2022, the contents of which are hereby incorporated by reference.

### BACKGROUND

### Field

The present disclosure relates to display systems and, more particularly, to augmented and virtual reality display systems and input coupling gratings (ICGs) or output coupling gratings for use therewith.

### Description of the Related Art

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, scenario is a type of AR scenario and typically involves virtual objects that are integrated into, and responsive to, the natural world. For example, in an MR scenario. AR image content may be blocked by or otherwise be perceived as interacting with objects in the real world.

Referring to FIG. 1, an augmented reality scene 10 is depicted wherein a user of an AR technology sees a real-world park-like setting 20 featuring people, trees, buildings in the background, and a concrete platform 30. In addition to these items, the user of the AR technology also perceives that he “sees” “virtual content” such as a robot statue 40 standing upon the real-world platform 30, and a cartoon-like avatar character 50 flying by which seems to be a personification of a bumble bee, even though these elements 40, 50 do not exist in the real world. Because the human visual perception system is complex, it is challenging to produce an AR technology that facilitates a comfortable, natural-feeling, rich presentation of virtual image elements amongst other virtual or real-world imagery elements.

Systems and methods disclosed herein address various challenges related to AR and VR technology.

### SUMMARY

Grating structures suitable for input coupling gratings (ICGs) for coupling light into a waveguide are described that are substantially insensitive to polarization, have low back reflection, and allow operation over a wide range of input angles are disclosed. Such grating structures can be used in inline alignment configurations where the ICG for multiple stacked waveguides are aligned along a common optical path. Such ICGs can be particularly useful for head-mounted displays using a microLED (μLED) light projection system, which can emit unpolarized light over a wide range of angles.

Examples of the grating structures include asymmetric blazed gratings either formed from a high index material and/or coated with a high index material (such as titanium dioxide, gallium phosphide, silicon carbide and others). Such high index layers can provide grating structures with relatively low optical losses. However, because the high index film the reflected light can be significant (e.g., >10% for some incident angles), unwanted back reflection coupling and ghosting, reduced contrast etc. in the virtual images can be an undesirable result. Reducing this back reflection can lead to more light being diffracted and coupled in the right order in TIR in the waveguide and thus benefits of reduced reflection can outweigh advantages of light recycling that may occur from the reflections.

The grating structures described herein can have low reflection with high diffraction efficiency in both TE and TM polarization modes. Such optical performance can enable overall eyepiece efficiency per Watt of energy used by the projectors, e.g., μLED projections systems, e.g., that use unpolarized light and ideally operate with reduced back reflection from grating structures into the lens of the projection system. Such grating structures can also work well for single active layer architectures where all colors (e.g., R, G, B) get waveguided in a single high index active layer but use grating structures working in transmission mode to harness use of high diffraction efficiency in orthogonal polarization states, e.g., enabling use of μLED projection systems.

Various aspects of the disclosed subject matter are summarized as follows. In general, in a first aspect, the disclosure features a head-mounted display system including: a head-mountable frame; a light projection system configured to output light to provide image content; a waveguide supported by the frame, the waveguide configured to guide at least a portion of the light from the light projection system coupled into the waveguide; and a grating structure optically coupled to the waveguide, the grating structure being configured to couple light from the light projection system into the waveguide. The grating structure includes: a grating layer comprising a plurality of ridges having a blaze profile in at least one cross-section; and one or more dielectric layers disposed on the grating layer, wherein, for unpolarized incident light at at least one operative wavelength of the output light, the grating structure has a mean launch efficiency of 40% or more (e.g., 45% or more, 50% or more, 55% or more, 60% or more, 65% or more. e.g., 75% or less, 70% or less, 65% or less, 60% or less, 55% or less) and a mean back reflection of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 100 or more (e.g., 15° or more, 20° or more, 22° or more, 25° or more, e.g., up to 45° or less, 40° or less, 35° or less, 30° or less, 25° or less, 220 or less) in at least one direction.

Implementations of the head mounted display can include one or more of the following features and/or features of other aspects. For example, for unpolarized incident light at at least two operative wavelengths of the output light at least 100 nm apart, the grating structure can have a mean launch efficiency of 40% or more (e.g., 45% or more, 50% or more, 55% or more, 60% or more, 65% or more, e.g., 75% or less, 70% or less, 65% or less, 60% or less, 55% or less) and a mean back reflection of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 100 or more (e.g., 15° or more, 20° or more, 22° or more, 250 or more, e.g., up to 45° or less, 40° or less, 35° or less, 30° or less, 25° or less, 22° or less) in at least one direction. For unpolarized incident light at three operative wavelengths of the output light spanning a spectral range of 120 nm or more (e.g., 150 nm or more, 200 nm or more, 250 nm or more, e.g., 500 nm or less, 400 nm or less, 300 nm or less, 250 nm or less, e.g., from 400 nm to 800 nm, e.g., from 430 nm to 650 nm), the grating structure can have a mean launch efficiency of 40% or more (e.g., 45% or more, 50% or more, 55% or more, 60% or more, 65% or more, e.g., 75% or less, 70% or less, 65% or less, 60% or less, 55% or less) and a mean back reflection of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 10° or more (e.g., 15° or more, 20° or more, 22° or more, 25° or more. e.g., up to 45° or less, 40° or less, 35° or less, 30° or less, 25° or less, 22° or less) in at least one direction. The three wavelengths can be a blue wavelength, a green wavelength, and a red wavelength. In some examples, the three wavelengths are 465 nm, 545 nm, and 625 nm.

The field of view can be 10° or more (e.g., 15° or more, 20° or more, 22° or more, 25° or more, e.g., up to 450 or less, 40° or less, 35° or less, 30° or less, 25° or less, 22° or less) orthogonal directions. In certain examples, the field of view is 22°×22° in orthogonal directions.

The grating structure can be a reflection grating structure or a transmission grating structure. The plurality of ridges can be slanted ridges.

The grating structure can include a metal layer disposed on the one or more dielectric layers.

The one or more dielectric layers can include at least one continuous layer.

In some examples, the one or more dielectric layers include at least one discontinuous layer.

The one or more dielectric layers can include a first dielectric layer disposed directly on the grating layer and a second dielectric layer disposed directly on the first dielectric layer, the first dielectric layer having a larger refractive index at the operative wavelength than a refractive index of the grating layer and a refractive index of the second dielectric layer.

The one or more dielectric layers can include a layer having a thickness in a range from 50 nm to 150 nm (e.g., 75 nm to 125 nm, 80 nm to 100 nm, 85 nm to 95 nm).

The one or more dielectric layers can include a first layer having a thickness in a range from 30 nm to 100 nm (e.g., 40 nm to 80 nm, 50 nm to 70 nm) and a second layer having a thickness in a range from 30 nm to 100 nm (e.g., 40 nm to 80 nm, 50 nm to 70 nm).

The plurality of ridges can have a pitch in a range from 200 nm to 500 nm (e.g., 250 nm to 450 nm, 300 nm to 400 nm, 325 nm to 375 nm, 350 nm to 370 nm).

The plurality of ridges can have a top width in a range from 50 nm to 150 nm (e.g., 60 nm to 140 nm, 70 nm to 130 nm, 80 nm to 100 nm).

The plurality of ridges can have a bottom width in a range from 10 nm to 150 nm (e.g., 20 nm to 120 nm, 50 nm to 100 nm).

The plurality of ridges have a blaze angle in a range from 20° to 50° (e.g., 25° to 45°, 30° to 40°). The plurality of ridges can have an anti-blaze angle in a range from 75° to 150° (e.g., 80° to 140°, 85° to 130°, 90° to 120°, 90° to 100°).

The launch efficiency of the grating structure can correspond to a first order diffraction efficiency of the grating structure.

The grating structure can be a first grating structure and the system can further include a second grating structure on an opposite side of the waveguide form the first grating structure. The first grating structure can be a reflection grating structure and the second grating structure can be a transmission grating structure. The second grating structure can include a grating layer with a plurality of ridges and at least one dielectric layer supported by the grating layer.

The ridges can have a profile shape selected from the group that includes: trapezoidal, parallelogram, triangular, and stepped.

The grating can have a duty cycle in a range from 5% to 95% (e.g., 10% to 75%, 20% to 50%, 30% to 40%).

The grating material can include a cross-linked polymer (e.g., a thermally or UV cross-linked polymer). The grating material can have a refractive index in a range from 1.5 to 1.8. The grating material can include nanoparticles (e.g., TiO₂ nanoparticles or ZrO₂ nanoparticles). The grating material can have a refractive index in a range from 1.5 to 2.1.

The waveguide can support a film of a material and the ridges are etched into the film. The material can be an inorganic material. The material can have a refractive index in a range from 1.8 to 2.8. The material can have a refractive index in a range from 1.38 to 1.45. The material can have a refractive index higher than a refractive index of the waveguide. The material can have a refractive index lower than a refractive index of the waveguide.

The grating structure can be configured to, during operation, couple light into the waveguide at operative wavelengths corresponding to multiple differently colored pixels of the light projection system.

The grating layer and the waveguide can be composed of the same material, which can include a polymer. The polymer can have a refractive index of 1.75 or less. The material can have a refractive index of 1.8 or more (e.g., 1.9 or more, 2.0 or more, 2.1 or more, e.g., 2.8 or less, 2.7 or less, 2.6 or less, 2.5 or less). The material can be a composite material (e.g., a composite material including nanoparticles).

The light from the light projection system can be unpolarized light.

The light projection system can include a microLED display, an LCoS display, or a laser beam scanner display.

The head-mounted display can include one or more additional waveguides and one or more additional grating structures each associated with a corresponding one of the additional waveguides. The grating structures of each of the waveguides can be arranged in an inline configuration. At least one of the grating structures can be a reflection grating. The reflection grating can be the grating structure of the waveguide furthest from the light projection system.

The waveguide and the light projection system can be arranged relative to each other so that the light from the projection system is incident on the grating structure from a non-normal direction relative to a surface of the waveguide. The light from the projection system can be incident on the grating structure at an angle in a range from 1° to 20° (e.g., 3° to 15°, 5° to 12°, 5° to 10°) relative to a surface normal of the waveguide.

In general, in another aspect, the disclosure features an article that includes: a waveguide layer; and a grating structure optically coupled to the waveguide, the grating structure being configured to couple light from the light projection system into the waveguide. The grating structure includes: a grating layer comprising a plurality of ridges having a blaze profile in at least one cross-section; and one or more dielectric layers disposed on the grating layer. For unpolarized incident light at at least one operative wavelength of the output light, the grating structure has a mean launch efficiency of 40% or more (e.g., 45% or more, 50% or more, 55% or more, 60% or more, 65% or more, e.g., 75% or less, 70% or less, 65% or less, 60% or less, 55% or less) and a mean back reflection of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 10° or more (e.g., 15° or more, 20° or more, 22° or more, 25° or more, e.g., up to 45° or less, 40° or less, 35° or less, 30° or less, 25° or less, 22° or less) in at least one direction.

Implementations of the article can include one or more of the features of the foregoing aspect.

Other features and advantages will be apparent from the drawings, the description below, and the claims.

### BRIEF DESCRIPTION OF THE DRAWINGS

FIG. 1 illustrates a user's view of augmented reality (AR) through an AR device.

FIG. 2 illustrates a conventional display system for simulating three-dimensional imagery for a user.

FIGS. 3A-3C illustrate relationships between radius of curvature and focal radius.

FIG. 4A illustrates a representation of the accommodation-vergence response of the human visual system.

FIG. 4B illustrates examples of different accommodative states and vergence states of a pair of eyes of the user.

FIG. 4C illustrates an example of a representation of a top-down view of a user viewing content via a display system.

FIG. 4D illustrates another example of a representation of a top-down view of a user viewing content via a display system.

FIG. 5 illustrates aspects of an approach for simulating three-dimensional imagery by modifying wavefront divergence.

FIG. 6 illustrates an example of a waveguide stack for outputting image information to a user.

FIG. 7 illustrates an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an incoupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 9D illustrates an example of wearable display system.

FIG. 10A schematically illustrates a cross-sectional view of a portion of a waveguide having disposed thereon a diffraction grating, for example, for in-coupling light into the waveguide.

FIG. 10B illustrates a cross-sectional view of a waveguide having disposed thereon a blazed diffraction grating showing a field-of-view (FOV) of the waveguide, Δα.

FIG. 11A shows cross-sectional views of portions of a grating structure in which a grating pattern is transferred from a resist layer to a substrate layer by dry etching.

FIG. 11B is an SEM micrograph of an example grating structure formed in the manner depicted in FIG. 11A.

FIG. 12 is a cross-sectional schematic view showing a single pitch length of a grating structure composed of a slanted grating with first and second coatings thereon.

FIG. 13A-13D are plots comparing diffraction efficiency and reflection for an example grating structure composed of two coatings (FIGS. 13A-13B) and on coating (FIGS. 13C-13D), respectively.

FIGS. 14A-14D compare the results of simulated diffraction efficiency (FIG. 14A) with measured diffraction efficiency (FIG. 14B) for grating structures depicted in FIGS. 14C and 14D, respectively.

FIG. 15A is a plot of measured diffraction efficiency for an example grating structure with a single coating.

FIG. 15B is a plot of measured diffraction efficiency for the example grating structure shown in FIG. 15A with a second coating.

FIG. 15C is a plot of measured reflection % as a function of wavelength for the grating structures shown in FIGS. 15A and 15B, respectively.

FIGS. 16A-16F are plots and SEM micrographs that compare diffraction efficiency as a function of angle for an example of a slanted grating with no coatings (FIGS. 16A-B), one coating (FIGS. 16C-D), and two coatings (FIGS. 16E-F), respectively.

FIG. 17A is a plot showing launch efficiency (as a %) for a red wavelength, a green wavelength, and a blue wavelength as function of polarization state for a first example of a transmission ICG.

FIG. 17B is a plot showing back reflection (as a %) for a red wavelength, a green wavelength, and a blue wavelength as function of polarization state for the first example of the transmission ICG.

FIGS. 18A-18C are plots showing, for TM polarization, reflection efficiency for zeroth order reflection, transmission efficiency for zeroth order transmission, and transmission efficiency for first order diffraction as a function of incident angle for the first example of the transmission ICG. Each plot shows the respective performance for a red (625 nm), a green (545 nm), and a blue (465 nm) wavelength.

FIGS. 18D-18F are plots showing, for TE polarization, reflection efficiency for zeroth order reflection, transmission efficiency for zeroth order transmission, and transmission efficiency for first order diffraction as a function of incident angle for the first example of the transmission ICG. Each plot shows the respective performance for a red (625 nm), a green (545 nm), and a blue (465 nm) wavelength.

FIGS. 18G-18I are plots showing, averaged for TM and TE polarization, reflection efficiency for zeroth order reflection, transmission efficiency for zeroth order transmission, and transmission efficiency for first order diffraction as a function of incident angle for the first example of the transmission ICG. Each plot shows the respective performance for a red (625 nm), a green (545 nm), and a blue (465 nm) wavelength.

FIG. 19A is a plot showing launch efficiency (as a %) for a red wavelength, a green wavelength, and a blue wavelength as function of polarization state for a second example of a transmission ICG.

FIG. 19B is a plot showing back reflection (as a %) for a red wavelength, a green wavelength, and a blue wavelength as function of polarization state for the second example of the transmission ICG.

FIG. 19C is a cross-sectional schematic view of a portion of the second example of the transmission ICG.

FIGS. 20A-20C are plots showing, for TM polarization, reflection efficiency for zeroth order reflection, transmission efficiency for zeroth order transmission, and transmission efficiency for first order diffraction as a function of incident angle for the second example of the transmission ICG. Each plot shows the respective performance for a red (625 nm), a green (545 nm), and a blue (465 nm) wavelength.

FIGS. 20D-20F are plots showing, for TE polarization, reflection efficiency for zeroth order reflection, transmission efficiency for zeroth order transmission, and transmission efficiency for first order diffraction as a function of incident angle for the second example of the transmission ICG. Each plot shows the respective performance for a red (625 nm), a green (545 nm), and a blue (465 nm) wavelength.

FIGS. 20G-20I are plots showing, averaged for TM and TE polarization, reflection efficiency for zeroth order reflection, transmission efficiency for zeroth order transmission, and transmission efficiency for first order diffraction as a function of incident angle for the second example of the transmission ICG. Each plot shows the respective performance for a red (625 nm), a green (545 nm), and a blue (465 nm) wavelength.

FIGS. 21A and 21B are plots showing the sensitivity analysis of launch efficiency and back-reflection performance for double coated slanted (first example) and blazed (second example) ICGs with respect to random design perturbation (+/−10 nm) in grating parameters.

FIG. 22 is a schematic diagram showing operation of a reflection ICG for a waveguide.

FIG. 23 is a schematic diagram showing structural features of an example reflection ICG.

FIG. 24A is a plot showing launch efficiency (as a %) for a red wavelength, a green wavelength, and a blue wavelength as function of polarization state for a first example of a reflection ICG.

FIG. 24B is a plot showing back reflection (as a %) for a red wavelength, a green wavelength, and a blue wavelength as function of polarization state for the first example of the reflection ICG.

FIGS. 25A-25C are plots showing, for TM polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 25D-25F are plots showing, for TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 25G-25I are plots showing, averaged for TM and TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIG. 26 is a cross-sectional schematic view of a portion of a second example of a reflection ICG.

FIG. 27A is a plot showing launch efficiency (as a %) for a red wavelength, a green wavelength, and a blue wavelength as function of polarization state for a first example of a reflection ICG.

FIG. 27B is a plot showing back reflection (as a %) for a red wavelength, a green wavelength, and a blue wavelength as function of polarization state for the first example of the reflection ICG.

FIGS. 28A-28C are plots showing, for TM polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 28D-28F are plots showing, for TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 28G-28I are plots showing, averaged for TM and TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIG. 29 is a cross-sectional schematic view of a portion of a third example of a reflection ICG.

FIG. 30 is a cross-sectional schematic view of a portion of a fourth example of a reflection ICG.

FIG. 31A is a plot showing launch efficiency (as a %) for a red wavelength, a green wavelength, and a blue wavelength as function of polarization state for a first example of a reflection ICG.

FIG. 31B is a plot showing back reflection (as a %) for a red wavelength, a green wavelength, and a blue wavelength as function of polarization state for the first example of the reflection ICG.

FIGS. 32A-32C are plots showing, for TM polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 32D-32F are plots showing, for TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIGS. 32G-32I are plots showing, averaged for TM and TE polarization, reflection efficiency for the −1 diffraction order, reflection efficiency for zeroth diffraction order, and transmission efficiency for +1 diffraction order as a function of incident angle for the first example of the reflection ICG. Each plot shows the respective performance for a red (625 nm), a green (545 nm), and a blue (465 nm) wavelength.

FIG. 33A is a cross-sectional schematic view of a portion of a fifth example of a reflection ICG.

FIG. 33B is a cross-sectional schematic view of a portion of another example of a transmission ICG.

FIG. 34A is a plot showing launch efficiency (as a %) for a red wavelength, a green wavelength, and a blue wavelength as function of polarization state for a fifth example of a reflection ICG.

FIG. 34B is a plot showing back reflection (as a %) for a red wavelength, a green wavelength, and a blue wavelength as function of polarization state for the fifth example of the reflection ICG.

FIGS. 35A-35C are plots showing, for TM polarization, reflection efficiency for the −1 diffraction order, reflection efficiency for zeroth diffraction order, and transmission efficiency for +1 diffraction order as a function of incident angle for the fifth example of the reflection ICG. Each plot shows the respective performance for a red (625 nm), a green (545 nm), and a blue (465 nm) wavelength.

FIGS. 35D-35F are plots showing, for TE polarization, reflection efficiency for the −1 diffraction order, reflection efficiency for zeroth diffraction order, and transmission efficiency for +1 diffraction order as a function of incident angle for the fifth example of the reflection ICG. Each plot shows the respective performance for a red (625 nm), a green (545 nm), and a blue (465 nm) wavelength.

FIGS. 35G-35I are plots showing, averaged for TM and TE polarization, reflection efficiency for the −1 diffraction order, reflection efficiency for zeroth diffraction order, and transmission efficiency for +1 diffraction order as a function of incident angle for the fifth example of the reflection ICG. Each plot shows the respective performance for a red (625 nm), a green (545 nm), and a blue (465 nm) wavelength.

FIGS. 36A-36C are plots of total electric field magnitude within a unit cell of each of the grating structures for the first, second, fourth and fifth examples of the reflection ICGs. The plots shown in FIG. 36A are for a red wavelength (625 nm). The plots shown in FIG. 36B are for a green wavelength (545 nm). The plots shown in FIG. 36C are for a blue wavelength (465 nm).

FIG. 37 is a plot of average polarization launch efficiency and back reflection (as a %) for the first and second transmission ICGs examples and the first, second, fourth and fifth reflection ICGs examples.

FIG. 38 is a cross-sectional schematic view of a portion of a sixth example of a reflection ICG.

FIG. 39 is cross-sectional schematic view of an example waveguide with a transmission ICG and a reflection ICG.

FIG. 40 is cross-sectional schematic view of another example waveguide with a transmission ICG and a reflection ICG.

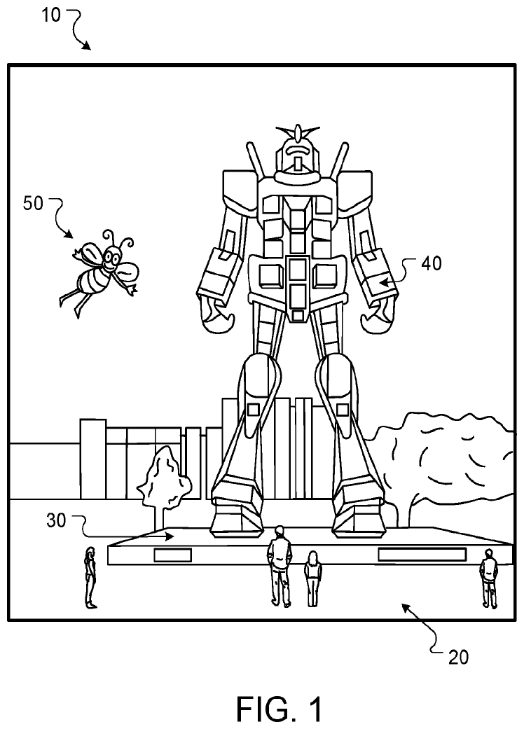

Throughout the drawings, reference numbers may be re-used to indicate correspondence between referenced elements. The drawings are provided to illustrate example embodiments described herein and are not intended to limit the scope of the disclosure.

### DETAILED DESCRIPTION

AR systems may display virtual content to a user, or viewer, while still allowing the user to see the world around them. Preferably, this content is displayed on a head-mounted display, e.g., as part of eyewear, that projects image information to the user's eyes. In addition, the display may also transmit light from the surrounding environment to the user's eyes, to allow a view of that surrounding environment. As used herein, it will be appreciated that a “head-mounted” or “head mountable” display is a display that may be mounted on the head of a viewer or user.

In some AR systems, virtual/augmented/mixed display having a relatively large field of view (FOV) can enhance the viewing experience. The FOV of the display depends on the angle of light output by waveguides of the eyepiece, through which the viewer sees images projected into his or her eye. A waveguide having a relatively high refractive index, e.g., 2.0 or greater, can provide a relatively high FOV. However, to efficiently couple light into the high refractive index waveguide, the diffractive optical coupling elements should also have a correspondingly high refractive index. To achieve this goal, among other advantages, some displays for AR systems according to embodiments described herein include a waveguide comprising a relatively high index (e.g., greater than or equal to 2.0) material, having formed thereon respective diffraction gratings with correspondingly high refractive index, such a Li-based oxide. For example, a diffraction grating may be formed directly on a Li-based oxide waveguide by patterning a surface portion of the waveguide formed of a Li-based oxide.

Some high refractive index diffractive optical coupling elements such as in-coupling or out-coupling optical elements have strong polarization dependence. For example, in-coupling gratings (ICGs) for in-coupling light into a waveguide wherein the diffractive optical coupling element comprises high refractive index material may admit light of a given polarization significantly more than light of another polarization. Such elements may, for example, in-couple light with TM polarization into the waveguide at a rate approximately 3 times that of light with TE polarization. Diffractive optical coupling elements with this kind of polarization dependence may have reduced efficiency (due to the poor efficiency and general rejection of one polarization) and may also create coherent artifacts and reduce the uniformity of a far field image formed by light coupled out of the waveguide. To obtain diffractive optical coupling elements that are polarization-insensitive or at least that have reduced polarization sensitivity (e.g., that couple light with an efficiency that is relatively independent of polarization), some displays for AR systems according to various implementations described herein include a waveguide with diffraction gratings formed with blazed geometries. The diffraction grating may also be formed directly in the waveguide, which may comprise high index material (e.g., having an index of refraction of at least 1.9, 2.0, 2.1, 2.2, 2.3, 2.4, 2.5, 2.6, or up to 2.7 or a value in any range between any of these values). A diffractive grating may, for example, be formed in high index materials such as such as Li-based oxide like lithium niobate (LiNbO₃) or lithium tantalate (LiTaO₃) or such as zirconium oxide (ZrO₂), titanium dioxide (TiO₂) or silicon carbide (SiC), for example, by patterning the high index material with a blazed geometry.

Reference will now be made to the drawings, in which like reference numerals refer to like parts throughout. Unless indicated otherwise, the drawings are schematic not necessarily drawn to scale.

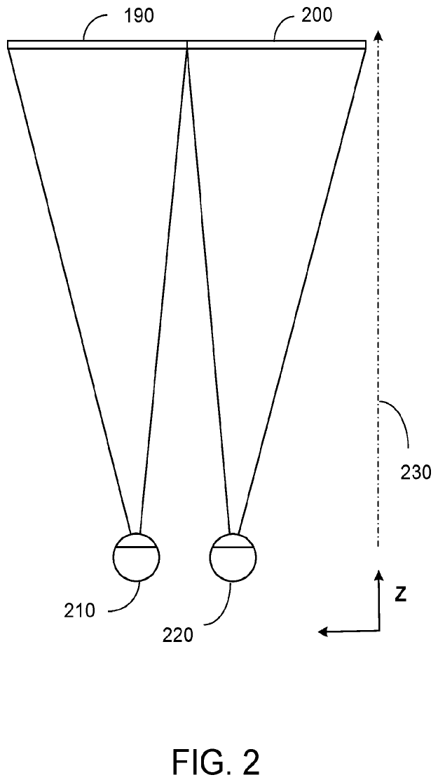

FIG. 2 illustrates a conventional display system for simulating three-dimensional imagery for a user. A user's eyes are spaced apart and that, when looking at a real object in space, each eye will have a slightly different view of the object and may form an image of the object at different locations on the retina of each eye. This may be referred to as binocular disparity and may be utilized by the human visual system to provide a perception of depth. Conventional display systems simulate binocular disparity by presenting two distinct images 190, 200 with slightly different views of the same virtual object—one for each eye 210. 220—corresponding to the views of the virtual object that would be seen by each eye were the virtual object a real object at a desired depth. These images provide binocular cues that the user's visual system may interpret to derive a perception of depth.

With continued reference to FIG. 2, the images 190, 200 are spaced from the eyes 210, 220 by a distance 230 on a z-axis. The z-axis is parallel to the optical axis of the viewer with their eyes fixated on an object at optical infinity directly ahead of the viewer. The images 190, 200 are flat and at a fixed distance from the eyes 210, 220. Based on the slightly different views of a virtual object in the images presented to the eyes 210, 220, respectively, the eyes may naturally rotate such that an image of the object falls on corresponding points on the retinas of each of the eyes, to maintain single binocular vision. This rotation may cause the lines of sight of each of the eyes 210, 220 to converge onto a point in space at which the virtual object is perceived to be present. As a result, providing three-dimensional imagery conventionally involves providing binocular cues that may manipulate the vergence of the user's eyes 210, 220, and that the human visual system interprets to provide a perception of depth.

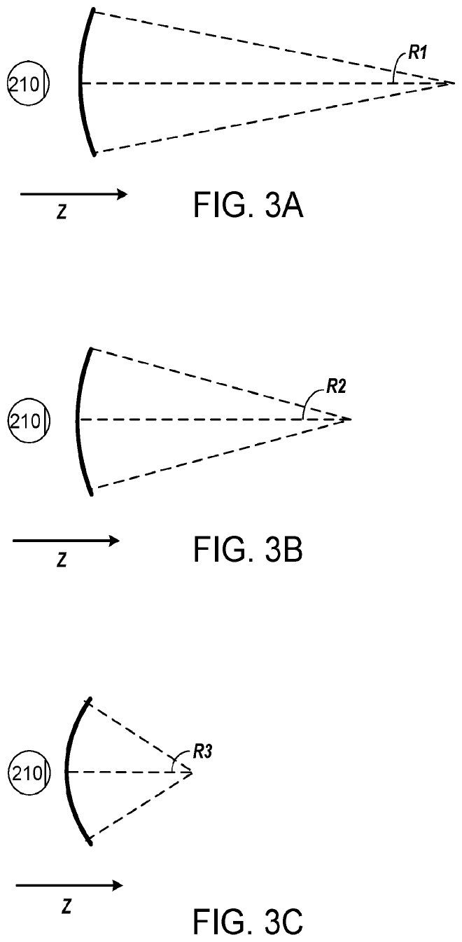

Generating a realistic and comfortable perception of depth is challenging, however. It will be appreciated that light from objects at different distances from the eyes have wavefronts with different amounts of divergence. FIGS. 3A-3C illustrate relationships between distance and the divergence of light rays. The distance between the object and the eye 210 is represented by, in order of decreasing distance, R1, R2, and R3. As shown in FIGS. 3A-3C, the light rays become more divergent as distance to the object decreases. Conversely, as distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. While only a single eye 210 is illustrated for clarity of illustration in FIGS. 3A-3C and other figures herein, the discussions regarding eye 210 may be applied to both eyes 210 and 220 of a viewer.

With continued reference to FIGS. 3A-3C, light from an object that the viewer's eyes are fixated on may have different degrees of wavefront divergence. Due to the different amounts of wavefront divergence, the light may be focused differently by the lens of the eye, which in turn may require the lens to assume different shapes to form a focused image on the retina of the eye. Where a focused image is not formed on the retina, the resulting retinal blur acts as a cue to accommodation that causes a change in the shape of the lens of the eye until a focused image is formed on the retina. For example, the cue to accommodation may trigger the ciliary muscles surrounding the lens of the eye to relax or contract, thereby modulating the force applied to the suspensory ligaments holding the lens, thus causing the shape of the lens of the eye to change until retinal blur of an object of fixation is eliminated or minimized, thereby forming a focused image of the object of fixation on the retina (e.g., fovea) of the eye. The process by which the lens of the eye changes shape may be referred to as accommodation, and the shape of the lens of the eye required to form a focused image of the object of fixation on the retina (e.g., fovea) of the eye may be referred to as an accommodative state.

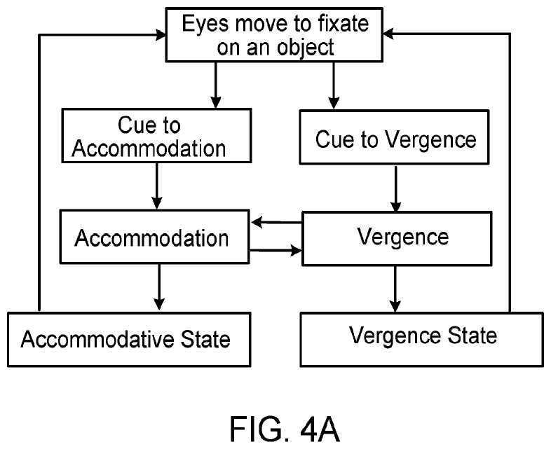

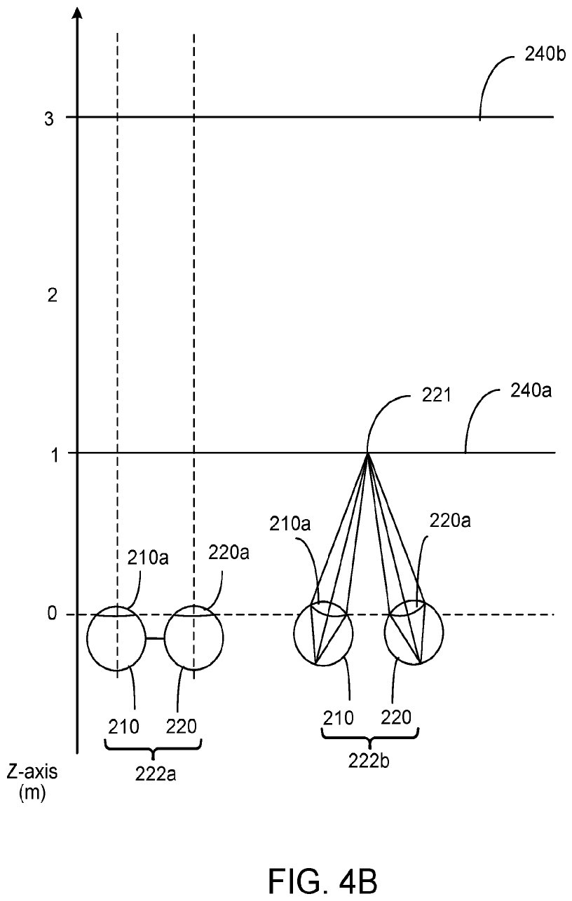

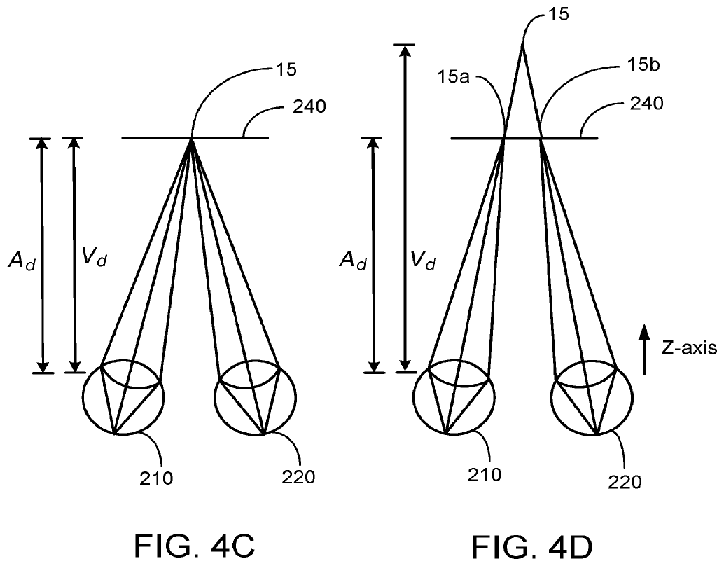

With reference now to FIG. 4A, a representation of the accommodation-vergence response of the human visual system is illustrated. The movement of the eyes to fixate on an object causes the eyes to receive light from the object, with the light forming an image on each of the retinas of the eyes. The presence of retinal blur in the image formed on the retina may provide a cue to accommodation, and the relative locations of the image on the retinas may provide a cue to vergence. The cue to accommodation causes accommodation to occur, resulting in the lenses of the eyes each assuming a particular accommodative state that forms a focused image of the object on the retina (e.g., fovea) of the eye. On the other hand, the cue to vergence causes vergence movements (rotation of the eyes) to occur such that the images formed on each retina of each eye are at corresponding retinal points that maintain single binocular vision. In these positions, the eyes may be said to have assumed a particular vergence state. With continued reference to FIG. 4A, accommodation may be understood to be the process by which the eye achieves a particular accommodative state, and vergence may be understood to be the process by which the eye achieves a particular vergence state. As indicated in FIG. 4A, the accommodative and vergence states of the eyes may change if the user fixates on another object. For example, the accommodated state may change if the user fixates on a new object at a different depth on the z-axis.

Without being limited by theory, it is believed that viewers of an object may perceive the object as being “three-dimensional” due to a combination of vergence and accommodation. As noted above, vergence movements (e.g., rotation of the eyes so that the pupils move toward or away from each other to converge the lines of sight of the eyes to fixate upon an object) of the two eyes relative to each other are closely associated with accommodation of the lenses of the eyes. Under normal conditions, changing the shapes of the lenses of the eyes to change focus from one object to another object at a different distance will automatically cause a matching change in vergence to the same distance, under a relationship known as the “accommodation-vergence reflex.” Likewise, a change in vergence will trigger a matching change in lens shape under normal conditions.

With reference now to FIG. 4B, examples of different accommodative and vergence states of the eyes are illustrated. The pair of eyes 222a is fixated on an object at optical infinity, while the pair eyes 222b are fixated on an object 221 at less than optical infinity. Notably, the vergence states of each pair of eyes is different, with the pair of eyes 222a directed straight ahead, while the pair of eyes 222 converge on the object 221. The accommodative states of the eyes forming each pair of eyes 222a and 222b are also different, as represented by the different shapes of the lenses 210a, 220a.

Undesirably, many users of conventional “3-D” display systems find such conventional systems to be uncomfortable or may not perceive a sense of depth at all due to a mismatch between accommodative and vergence states in these displays. As noted above, many stereoscopic or “3-D” display systems display a scene by providing slightly different images to each eye. Such systems are uncomfortable for many viewers, since they, among other things, simply provide different presentations of a scene and cause changes in the vergence states of the eyes, but without a corresponding change in the accommodative states of those eyes. Rather, the images are shown by a display at a fixed distance from the eyes, such that the eyes view all the image information at a single accommodative state. Such an arrangement works against the “accommodation-vergence reflex” by causing changes in the vergence state without a matching change in the accommodative state. This mismatch is believed to cause viewer discomfort. Display systems that provide a better match between accommodation and vergence may form more realistic and comfortable simulations of three-dimensional imagery.

Without being limited by theory, it is believed that the human eye typically may interpret a finite number of depth planes to provide depth perception. Consequently, a highly believable simulation of perceived depth may be achieved by providing, to the eye, different presentations of an image corresponding to each of these limited numbers of depth planes. In some embodiments, the different presentations may provide both cues to vergence and matching cues to accommodation, thereby providing physiologically correct accommodation-vergence matching.

With continued reference to FIG. 4B, two depth planes 240, corresponding to different distances in space from the eyes 210, 220, are illustrated. For a given depth plane 240, vergence cues may be provided by the displaying of images of appropriately different perspectives for each eye 210, 220. In addition, for a given depth plane 240, light forming the images provided to each eye 210, 220 may have a wavefront divergence corresponding to a light field produced by a point at the distance of that depth plane 240.

In the illustrated embodiment, the distance, along the z-axis, of the depth plane 240 containing the point 221 is 1 m. As used herein, distances or depths along the z-axis may be measured with a zero-point located at the exit pupils of the user's eyes. Thus, a depth plane 240 located at a depth of 1 m corresponds to a distance of 1 m away from the exit pupils of the user's eyes, on the optical axis of those eyes with the eyes directed towards optical infinity. As an approximation, the depth or distance along the z-axis may be measured from the display in front of the user's eyes (e.g., from the surface of a waveguide), plus a value for the distance between the device and the exit pupils of the user's eyes. That value may be called the eye relief and corresponds to the distance between the exit pupil of the user's eye and the display worn by the user in front of the eye. In practice, the value for the eye relief may be a normalized value used generally for all viewers. For example, the eye relief may be assumed to be 20 mm and a depth plane that is at a depth of 1 m may be at a distance of 980 mm in front of the display.

With reference now to FIGS. 4C and 4D, examples of matched accommodation-vergence distances and mismatched accommodation-vergence distances are illustrated, respectively. As illustrated in FIG. 4C, the display system may provide images of a virtual object to each eye 210, 220. The images may cause the eyes 210, 220 to assume a vergence state in which the eyes converge on a point 15 on a depth plane 240. In addition, the images may be formed by a light having a wavefront curvature corresponding to real objects at that depth plane 240. As a result, the eyes 210, 220 assume an accommodative state in which the images are in focus on the retinas of those eyes. Thus, the user may perceive the virtual object as being at the point 15 on the depth plane 240.

It will be appreciated that each of the accommodative and vergence states of the eyes 210, 220 are associated with a particular distance on the z-axis. For example, an object at a particular distance from the eyes 210, 220 causes those eyes to assume particular accommodative states based upon the distances of the object. The distance associated with a particular accommodative state may be referred to as the accommodation distance. Ad. Similarly, there are particular vergence distances, Vd, associated with the eyes in particular vergence states, or positions relative to one another. Where the accommodation distance and the vergence distance match, the relationship between accommodation and vergence may be said to be physiologically correct. This is considered to be the most comfortable scenario for a viewer.

In stereoscopic displays, however, the accommodation distance and the vergence distance may not always match. For example, as illustrated in FIG. 4D, images displayed to the eyes 210, 220 may be displayed with wavefront divergence corresponding to depth plane 240, and the eyes 210, 220 may assume a particular accommodative state in which the points 15a, 15b on that depth plane are in focus. However, the images displayed to the eyes 210, 220 may provide cues for vergence that cause the eyes 210, 220 to converge on a point 15 that is not located on the depth plane 240. As a result, the accommodation distance corresponds to the distance from the exit pupils of the eyes 210, 220 to the depth plane 240, while the vergence distance corresponds to the larger distance from the exit pupils of the eyes 210, 220 to the point 15, in some embodiments. The accommodation distance is different from the vergence distance. Consequently, there is an accommodation-vergence mismatch. Such a mismatch is considered undesirable and may cause discomfort in the user. It will be appreciated that the mismatch corresponds to distance (e.g., Vd-Ad) and may be characterized using diopters.

In some embodiments, it will be appreciated that a reference point other than exit pupils of the eyes 210, 220 may be utilized for determining distance for determining accommodation-vergence mismatch, so long as the same reference point is utilized for the accommodation distance and the vergence distance. For example, the distances could be measured from the cornea to the depth plane, from the retina to the depth plane, from the eyepiece (e.g., a waveguide of the display device) to the depth plane, and so on.

Without being limited by theory, it is believed that users may still perceive accommodation-vergence mismatches of up to about 0.25 diopter, up to about 0.33 diopter, and up to about 0.5 diopter as being physiologically correct, without the mismatch itself causing significant discomfort. In some embodiments, display systems disclosed herein (e.g., the display system 250, FIG. 6) present images to the viewer having accommodation-vergence mismatch of about 0.5 diopter or less. In some other embodiments, the accommodation-vergence mismatch of the images provided by the display system is about 0.33 diopter or less. In yet other embodiments, the accommodation-vergence mismatch of the images provided by the display system is about 0.25 diopter or less, including about 0.1 diopter or less.

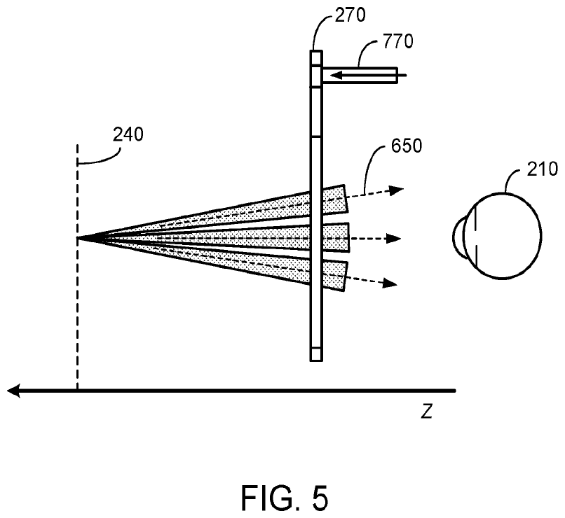

FIG. 5 illustrates aspects of an approach for simulating three-dimensional imagery by modifying wavefront divergence. The display system includes a waveguide 270 that is configured to receive light 770 that is encoded with image information, and to output that light to the user's eye 210. The waveguide 270 may output the light 650 with a defined amount of wavefront divergence corresponding to the wavefront divergence of a light field produced by a point on a desired depth plane 240. In some embodiments, the same amount of wavefront divergence is provided for all objects presented on that depth plane. In addition, it will be illustrated that the other eye of the user may be provided with image information from a similar waveguide.

In some embodiments, a single waveguide may be configured to output light with a set amount of wavefront divergence corresponding to a single or limited number of depth planes and/or the waveguide may be configured to output light of a limited range of wavelengths. Consequently, in some embodiments, a plurality or stack of waveguides may be utilized to provide different amounts of wavefront divergence for different depth planes and/or to output light of different ranges of wavelengths. As used herein, it will be appreciated at a depth plane may be planar or may follow the contours of a curved surface.

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. It will be appreciated that the display system 250 may be considered a light field display in some embodiments. In addition, the waveguide assembly 260 may also be referred to as an eyepiece.

In some embodiments, the display system 250 is configured to provide substantially continuous cues to vergence and multiple discrete cues to accommodation. The cues to vergence can be provided by displaying different images to each of the eyes of the user, and the cues to accommodation may be provided by outputting the light that forms the images with selectable discrete amounts of wavefront divergence. Stated another way, the display system 250 may be configured to output light with variable levels of wavefront divergence. In some embodiments, each discrete level of wavefront divergence corresponds to a particular depth plane and may be provided by a particular one of the waveguides 270, 280, 290, 300, 310.

With continued reference to FIG. 6, the waveguide assembly 260 may also include a plurality of features 320, 330, 340, 350 between the waveguides. In some embodiments, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and can be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some embodiments, each of the input surfaces 460, 470, 480.490, 500 may be an edge of a corresponding waveguide, or may be part of a major surface of the corresponding waveguide (that is, one of the waveguide surfaces directly facing the world 510 or the viewer's eye 210). In some embodiments, a single beam of light (e.g., a collimated beam) may be injected into each waveguide to output an entire field of cloned collimated beams that are directed toward the eye 210 at particular angles (and amounts of divergence) corresponding to the depth plane associated with a particular waveguide. In some embodiments, a single one of the image injection devices 360, 370, 380, 390, 400 may be associated with and inject light into a plurality (e.g., three) of the waveguides 270, 280, 290, 300, 310.

In some embodiments, the image injection devices 360, 370, 380, 390, 400 are discrete displays that each produce image information for injection into a corresponding waveguide 270, 280, 290, 300, 310, respectively. In some other embodiments, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some embodiments, the light injected into the waveguides 270, 280, 290, 300, 310 is provided by a light projector system 520, which comprises a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310 to encode the light with image information. Examples of spatial light modulators include liquid crystal displays (LCD) including a liquid crystal on silicon (LCOS) displays. It will be appreciated that the image injection devices 360, 370, 380, 390, 400 are illustrated schematically and, in some embodiments, these image injection devices may represent different light paths and locations in a common projection system configured to output light into associated ones of the waveguides 270, 280, 290, 300, 310. In some embodiments, the waveguides of the waveguide assembly 260 may function as ideal lens while relaying light injected into the waveguides out to the user's eyes. In this conception, the object may be the spatial light modulator 540 and the image may be the image on the depth plane.

In some examples, μLED displays can be used in light projector system 520. μLED displays can unpolarized light over a large range of angles. Accordingly, μLED displays can beneficially provide imagery over wide fields of view with high efficiency.

In some embodiments, the display system 250 may be a scanning fiber display comprising one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some embodiments, the illustrated image injection devices 360, 370, 380, 390, 400 may schematically represent a single scanning fiber or a bundle of scanning fibers configured to inject light into one or a plurality of the waveguides 270, 280, 290, 300, 310. In some other embodiments, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning, fiber into the one or more waveguides 270, 280, 290, 300, 310.

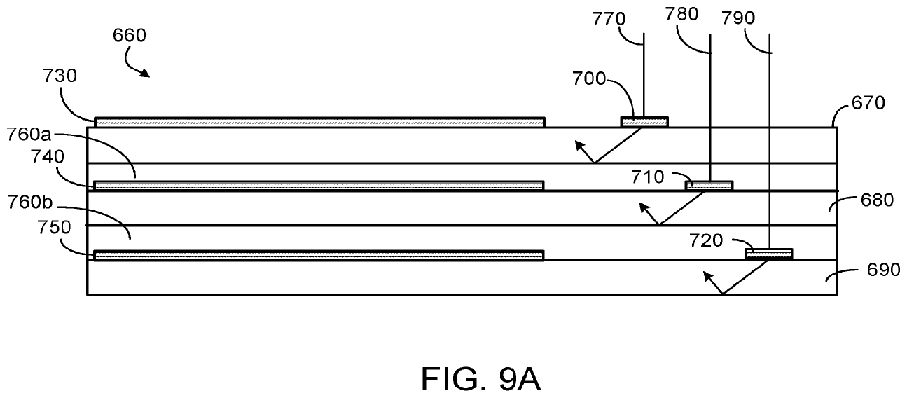

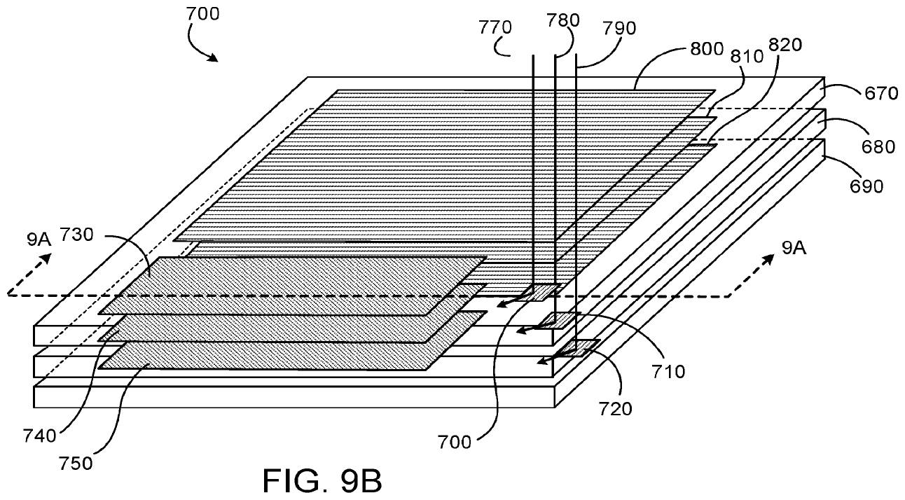

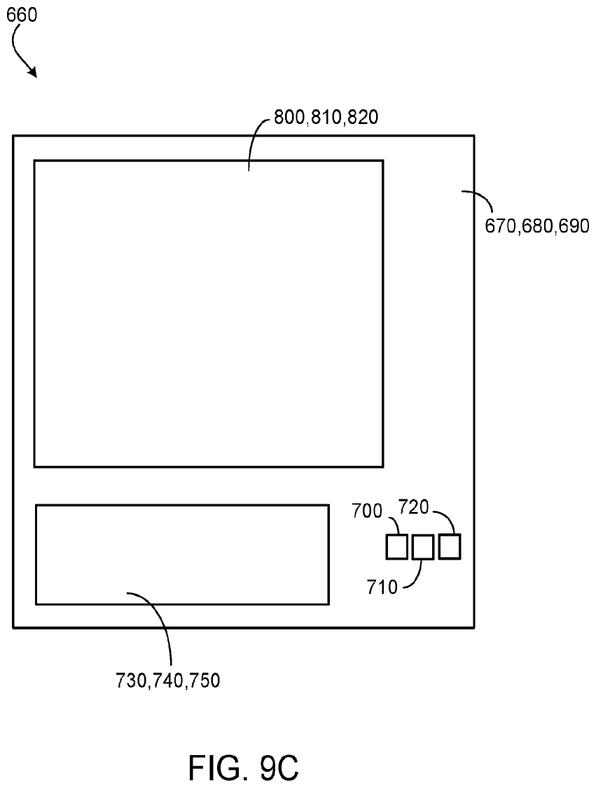

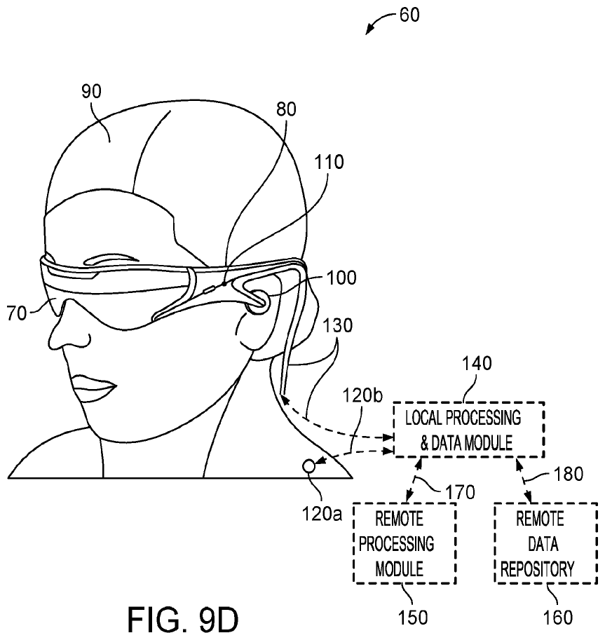

A controller 560 controls the operation of one or more of the stacked waveguide assembly 260, including operation of the image injection devices 360, 370, 380, 390, 400, the light source 530, and the light modulator 540. In some embodiments, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some embodiments, the controller may be a single integral device, or a distributed system connected by wired or wireless communication channels. The controller 560 may be part of the processing modules 140 or 150 (FIG. 9D) in some embodiments.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280.290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings, including diffractive optical features, as discussed further herein. While illustrated disposed at the bottom major surfaces of the waveguides 270, 280, 290, 300, 310, for ease of description and drawing clarity, in some embodiments, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some embodiments, the out-coupling optical elements 570, 580, 590, 600, 610 may be formed in a layer of material that is attached to a transparent substrate to form the waveguides 270, 280, 290, 300, 310. In some other embodiments, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it may reach the eye 210; such first lens 350 may be configured to create a slight convex wavefront curvature so that the eye/brain interprets light coming from that next waveguide up 280 as coming from a first focal plane closer inward toward the eye 210 from optical infinity. Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative embodiments, either or both may be dynamic using electro-active features.

In some embodiments, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. Ibis may provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some embodiments, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some embodiments, the features 320, 330, 340, 350 may not be lenses; rather, they may simply be spacers (e.g., cladding layers and/or structures for forming air gaps).

In some embodiments, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some embodiments, one or more DOEs may be switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some embodiments, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some embodiments, the camera assembly 630 may include an image capture device and a light source to project light (e.g., infrared light) to the eye, which may then be reflected by the eye and detected by the image capture device. In some embodiments, the camera assembly 630 may be attached to the frame 80 (FIG. 9D) and may be in electrical communication with the processing modules 140 and/or 150, which may process image information from the camera assembly 630. In some embodiments, one camera assembly 630 may be utilized for each eye, to separately monitor each eye.

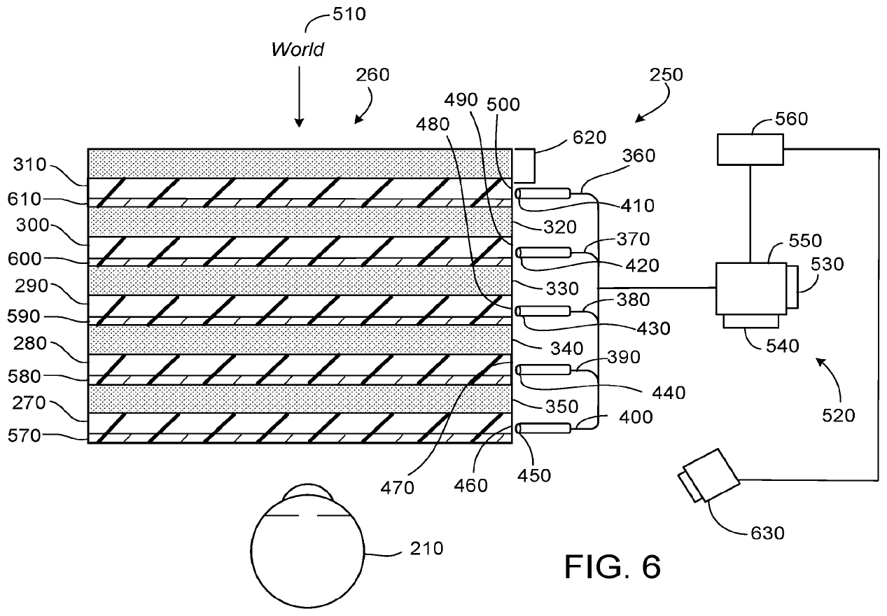

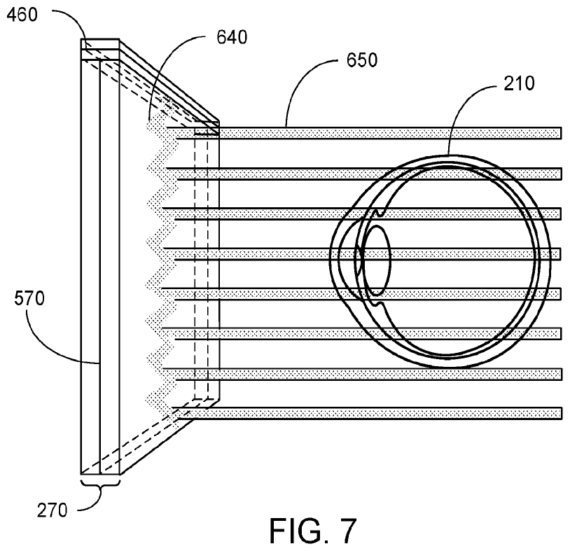

With reference now to FIG. 7, an example of exit beams outputted by a waveguide is shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated as substantially parallel but, as discussed herein, they may also be redirected to propagate to the eye 210 at an angle (e.g., forming divergent exit beams), depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

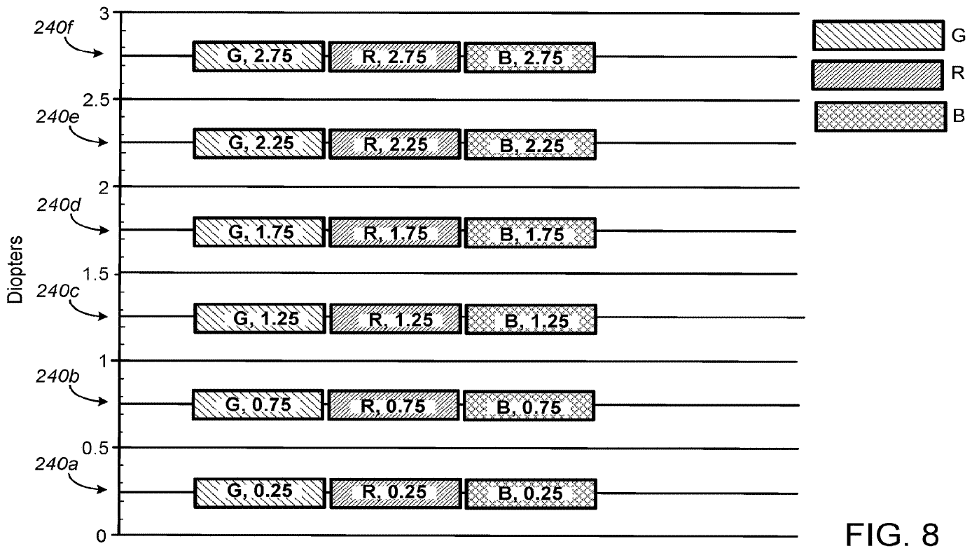

In some embodiments, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated embodiment shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (1/m), or inverse distance of the depth plane from a viewer, and each box in the figures represents an individual component color image. In some embodiments, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some embodiments, light of each component color may be outputted by a single dedicated waveguide and, consequently, each depth plane may have multiple waveguides associated with it. In such embodiments, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other embodiments, multiple component colors may be outputted by the same waveguide, such that, e.g., only a single waveguide may be provided per depth plane.

With continued reference to FIG. 8, in some embodiments, G is the color green, R is the color red, and B is the color blue. In some other embodiments, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some embodiments, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210. e.g., for imaging and/or user stimulation applications.

With reference now to FIG. 9A, in some embodiments, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element.

The waveguides may each be configured to output light of one or more different wavelengths, or one or more different ranges of wavelengths. It will be appreciated that the stack 660 may correspond to the stack 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some embodiments, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some embodiments, the in-coupling optical elements 700, 710, 720 may be disposed in the body of the respective waveguide 670, 680, 690. In some embodiments, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some embodiments.

As illustrated, the in-coupling optical elements 700, 710, 720 may be laterally offset from one another. In some embodiments, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other embodiments, the light distributing elements 730, 740, 750, may be disposed on a bottom major surface of associated waveguides 670, 680, 690, respectively. In some other embodiments, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid lavers of material. For example, as illustrated, layer 760a may separate waveguides 670 and 680; and layer 760b may separate waveguides 680 and 690. In some embodiments, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate total internal reflection (TIR) of light through the waveguides 670, 680, 690 (e.g., TIR between the top and bottom major surfaces of each waveguide). In some embodiments, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some embodiments, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some embodiments, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some embodiments, the incoupling optical elements 700, 710, 720 each selectively deflect one or more particular wavelengths of light, while transmitting other wavelengths to an underlying waveguide and associated incoupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some embodiments, the light distributing elements 730, 740, 750 are orthogonal pupil expanders (OPE's). In some embodiments, the OPE's deflect or distribute light to the out-coupling optical elements 800, 810, 820 and, in some embodiments, may also increase the beam or spot size of this light as it propagates to the out-coupling optical elements. In some embodiments, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some embodiments, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of incoupled light may be “replicated” each time a portion of that light is redirected by an OPE or EPE, thereby forming a field of cloned beams of light, as shown in FIG. 6. In some embodiments, the OPE and/or EPE may be configured to modify a size of the beams of light.

Accordingly, with reference to FIGS. 9A and 9B, in some embodiments, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one. The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The out-coupling optical element 820 then finally out-couples the light ray 790 to the viewer, who also receives the out-coupled light from the other waveguides 670, 680.

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are non-overlapping (e.g., laterally spaced apart as seen in the top-down view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially-separated in-coupling optical elements may be referred to as a shifted pupil system, and the in-coupling optical elements within these arrangements may correspond to sub pupils.

Alternatively, in certain embodiments, two or more of the in-coupling optical elements can be in an inline arrangement, in which they are vertically aligned. In such arrangements, light for waveguides further from the projection system is transmitted through the in-coupling optical elements for waveguides closer to the projection system, preferably with minimal scattering or diffraction.

Inline configurations can advantageously reduce the size of and simplify the projector. Moreover, it can increase the field of view of the eyepiece, e.g., by coupling of same color to several waveguides by making use of crosstalk. For example, green light can be coupled into blue and red active layers. Because of the pitch of each ICG can be different to provide improved (e.g., optimal) performance for a specific color, the allowed field of view can be increased.

In inline configurations, except for the last layer in the optical path, the ICGs should be either at most partially reflective or otherwise transmissive to light having operative wavelengths of subsequent layers in the waveguide stack. In either case, the efficiency can be undesirably low unless the gratings are etched in a high index layer (e.g., 1.8 or more for polymer based layers), or a high index coating is deposited or growth on the grating. However, this approach can increase the back reflection into the projector lens, which thus can generate image artifacts such as image ghosting.

FIG. 9D illustrates an example of wearable display system 60 into which the various waveguides and related systems disclosed herein may be integrated. In some embodiments, the display system 60 is the system 250 of FIG. 6, with FIG. 6 schematically showing some parts of that system 60 in greater detail. For example, the waveguide assembly 260 of FIG. 6 may be part of the display 70.

With continued reference to FIG. 9D, the display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some embodiments. In some embodiments, a speaker 100 is coupled to the frame 80 and configured to be positioned adjacent the ear canal of the user 90 (in some embodiments, another speaker, not shown, may optionally be positioned adjacent the other ear canal of the user to provide stereo/shapeable sound control). The display system 60 may also include one or more microphones 110 or other devices to detect sound. In some embodiments, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some embodiments, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing a physiological state of the user 90 in some embodiments. For example, the sensor 120a may be an electrode.

With continued reference to FIG. 9D, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may comprise a hardware processor, as well as digital memory, such as non-volatile memory (e.g., flash memory or hard disk drives), both of which may be utilized to assist in the processing, caching, and storage of data. Optionally, the local processor and data module 140 may include one or more central processing units (CPUs), graphics processing units (GPUs), dedicated processing hardware, and so on. The data may include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some embodiments, the local processing and data module 140 may include one or more of the image capture devices, microphones, inertial measurement units, accelerometers, compasses, GPS units, radio devices, and/or gyros. In some other embodiments, one or more of these sensors may be attached to the frame 80 or may be standalone structures that communicate with the local processing and data module 140 by wired or wireless communication pathways.

With continued reference to FIG. 9D, in some embodiments, the remote processing module 150 may comprise one or more processors configured to analyze and process data and/or image information, for instance including one or more central processing units (CPUs), graphics processing units (GPUs), dedicated processing hardware, and so on. In some embodiments, the remote data repository 160 may comprise a digital data storage facility, which may be available through the internet or other networking configuration in a “cloud” resource configuration. In some embodiments, the remote data repository 160 may include one or more remote servers, which provide information, e.g., information for generating augmented reality content, to the local processing and data module 140 and/or the remote processing module 150. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, modules 140, 150, 160, for instance via wireless or wired connections.

### Diffraction Gratings Having Reduced Polarization Sensitivity

Providing a high quality immersive experience to a user of waveguide-based display systems such as various display systems configured for virtual/augmented/mixed display applications described supra, depends on, among other things, various characteristics of the light coupling into and/or out of the waveguides in the eyepiece of the display systems. For example, a virtual/augmented/mixed display having high light incoupling and outcoupling efficiencies can enhance the viewing experience by increasing brightness of the light directed to the user's eye. As discussed above, in-coupling optical elements such as in-coupling diffraction gratings may be employed to couple light into the waveguides to be guided therein by total internal reflection. Similarly, out-coupling optical elements such as out-coupling diffraction gratings may be employed to couple light guided within the waveguides by total internal reflection out of the waveguides.

As described supra, e.g., in reference to FIGS. 6 and 7, display systems according to various implementations described herein may include optical elements, e.g., in-coupling optical elements, out-coupling optical elements, light distributing elements, and/or combined pupil expander-extractors (CPEs) that may include diffraction gratings. As disclosed herein, a CPE may operate both as a light distributing element spreading or distributing light within the waveguide, possibly increasing beam size and/or the eye box, as well as an out-coupling optical element coupling light out of the waveguide.

For example, as described above in reference to FIG. 7, light 640 that is injected into the waveguide 270 at the input surface 460 of the waveguide 270 propagates and is guided within the waveguide 270 by total internal reflection (TIR). In various implementation, at points where the light 640 impinges on the out-coupling optical element 570, a portion of the light guided within the waveguide may exit the waveguide as beamlets 650. In some implementations, any of the optical elements 570, 580, 590, 600, 610, which may include one or more of an incoupling optical element, an outcoupling optical element, a light distribution element or a CPE, can be configured as a diffraction grating.

To achieve desirable characteristics of in-coupling of light into (or out-coupling of light from) the waveguides 270, 280, 290, 300, 310, the optical elements 570, 580, 590, 600, 610 configured as diffraction gratings can be formed of a suitable material and have a suitable structure for controlling various optical properties, including diffraction properties such as diffraction efficiency as a function of polarization. Possible desirable diffraction properties may include, among other properties, any one or more of the following: spectral selectivity, angular selectivity, polarization selectivity (or non-selectivity), high spectral bandwidth, high diffraction efficiencies or a wide field of view (FOV).

Some diffraction gratings have strong polarization dependence and thus may have relatively diminished overall efficiency (due to the rejection of one polarization). Such diffraction gratings may also create coherent artifacts and reduce the uniformity of a far field image. To provide diffraction gratings that have reduced polarization sensitivity (e.g., that couple light with an efficiency that is relatively independent of polarization), some displays for AR systems according to implementation described herein include a waveguide with blazed diffraction gratings formed therein. The blazed grating may, for example, comprise diffractive features having a “saw tooth” shape. In some implementations, a blazed grating may achieve enhanced grating diffraction efficiency for a given diffraction order, while the diffraction efficiency for the other orders is reduced or minimized. As a result, more light may be directed into the particular given diffractive order as opposed to any of the other orders in some implementations.

### Transmission ICGs

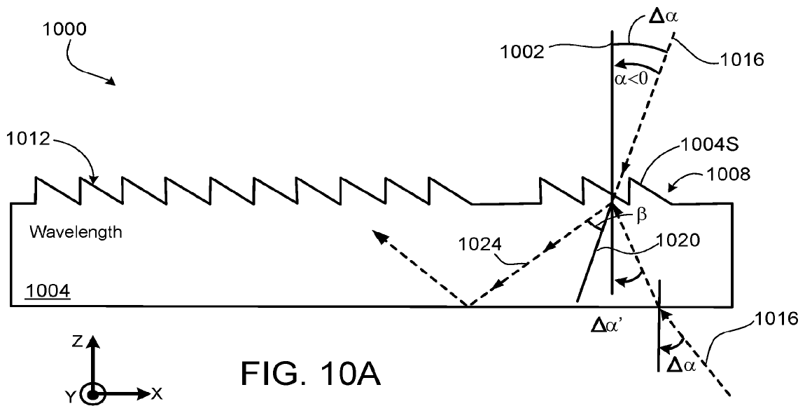

In certain examples, the diffraction gratings described herein can be transmission ICGs for coupling incident light into a waveguide. Such diffraction gratings are referred to as transmission diffraction gratings, e.g., transmission ICGs which launch light into the waveguide via transmissive diffraction orders, e.g., T₁₀. For example, FIG. 10A illustrates a cross-sectional view of a portion of a display device 1000 such as an eyepiece comprising a waveguide 1004 and a blazed diffraction grating 1008 formed on the substrate that is a waveguide 1004, according to some designs described herein. In the implementation shown, the blazed diffraction grating 1008 is formed in the substrate/waveguide 1004 (which, in this example, is planar). The surface of the substrate or waveguide 1004 has a surface topography comprising diffractive features that together form the diffraction grating 1008. The blazed diffraction grating 1008 is configured to diffract light having a wavelength in the visible spectrum such that the light incident thereon is guided within the waveguide 1004 by TIR. The waveguide 1004 may be transparent and may form part of an eyepiece through which a user's eye can see. Such a waveguide 1004 and eyepiece may be included in a head mounted display such as an augmented reality display. The waveguide 1004 can correspond, for example, to one of waveguides 670, 680, 690 described above with respect to FIGS. 9A-9C, for example. The blazed diffraction grating 1008 can correspond to one of the in-coupling optical elements 700, 710, 720 described above with respect to FIGS. 9A-9C, for example. The blazed diffraction grating 1008 configured to in-couple light into the waveguide 1004 may be referred to herein as an in-coupling grating (ICG). The display device 1000 may additionally include an optical element 1012, that can correspond, for example, to a light distributing element (e.g., one of the light distributing elements 730, 740, 750 shown in FIGS. 9A-9C), or an out-coupling optical element (e.g., one of the out-coupling optical elements 800, 810, 820 shown in FIGS. 9A-9C).

In operation, when an incident light beam 1016, e.g., visible light, such as from a light projection system that provide image content is incident on the blazed diffraction grating 1008 at an angle of incidence, α, measured relative to a plane normal 1002 that is normal or orthogonal to the extended surface or plane of the blazed diffraction grating or the substrate/waveguide and/or the surface 1004S of the waveguide 1004, for example, a major surface of the waveguide on which the grating is formed (shown in FIG. 10A as extending parallel to the y-x plane), the blazed diffraction grating at least partially diffracts the incident light beam 1016 as a diffracted light beam 1024 at a diffraction angle θ measured relative to the plane normal 1002. When the diffracted light beam 1024 is diffracted at a diffraction angle θ that exceeds a critical angle θ_{TIR} for occurrence of total internal reflection in the waveguide 1004, the diffracted light beam 1024 propagates and is guided within the waveguide 1004 via total internal reflection (TIR) generally along a direction parallel to the x-axis and along the length of the waveguide. A portion of this light guided within the waveguide 1004 may reach one of light distributing elements 730, 740, 750 or one of out-coupling optical elements (800, 810, 820, FIGS. 9A-9C), for example, and be diffracted again.

As described herein, a light beam that is incident at an angle in a clockwise direction relative to the plane normal 1002 (i.e., on the right side of the plane normal 1002) as in the illustrated implementation is referred to as having a negative α (α<0), whereas a light beam that is incident at an angle in a counter-clockwise direction relative to the plane normal 1002 (i.e., on the left side of the plane normal) is referred to as having a positive α (α>0).

As further described elsewhere in the specification, a suitable combination of high index material and/or the structure of the diffraction grating 1008 may result in a particular range (Δα) of angle of incidence α, referred to herein as a range of angles of acceptance or a field-of-view (FOV). One range. Δα, may be described by a range of angles spanning negative and/or positive values of α, outside of which the diffraction efficiency falls off by more than 10%, 25%, more than 50%, or more than 75%, 80%, 90%, 95%, or any value in a range defined by any of these values, relative to the diffraction efficiency at α=0 or some other direction. In some implementations, having Δα within the range in which the diffraction efficiency is relatively high and constant may be desirable, e.g., where a uniform intensity of diffracted light is desired within the Δα. Thus, in some implementations, Δα is associated with the angular bandwidth of the diffraction grating 1008, such that an incident light beam 1016 within the Δα is efficiently diffracted by the diffraction grating 1008 at a diffraction angle θ with respect to the surface normal 1002 (e.g., a direction parallel to the y-z plane) wherein θ exceeds θ_{TIR} such that the diffracted light is guided within the waveguide 1004 under total internal reflection (TIR). In some implementations, this angle Δα range may affect the field-of-view seen by the user. It will be appreciated that, in various implementations, the light can be directed onto the in-coupling grating (ICG) from either side. For example, the light can be directed through the substrate or waveguide 1004 and be incident onto a reflective in-coupling grating (ICG) 1008 such as the one shown in FIG. 10A. The light may undergo the same effect, e.g., be coupled into the substrate or waveguide 1004 by the in-coupling grating 1008 such that the light is guided within substrate or waveguide by total internal reflection. The range (Δα) of angle of incidence α, referred to herein as a range of angles of acceptance or a field-of-view (FOV) may be affected by the index of refraction of the substrate or waveguide material. In FIG. 10A, for example, a reduced range of angles (Δα′), shows the effects of refraction of the high index material on the light incident on the in-coupling grating (ICG). The range of angles (Δα) or FOV, however, is larger.

FIG. 10B illustrates a cross-sectional view of an example blazed transmission diffraction grating 1008. The grating 1008 comprises grating features having peaks 1003 and grooves 1005. The blazed transmission grating 1008 comprises a surface corresponding to the surface of the substrate or waveguide 1004S having a “sawtooth” shape pattern as viewed from the cross-section shown. The “sawtooth” patterned is formed by first sloping portions 1007 of the surface 1004S. In the example shown in FIG. 10B, the grating 1008 also includes second (steeper) sloping portions 1009. In the example shown, the first sloping portions 1007 have a shallower inclination than the second sloping portions 1009, which have a steeper inclination. The first sloping portions 1007 also are wider than the second sloping portions 1009 in this example.

The peaks 1003 have heights, H, corresponding to the distance from the bottom of the groove 1005 to the top of the peak 1003. Accordingly, this value may be referred to herein as the peak height and/or groove depth, as the grating height or grating depth or as the height of the diffractive features of the diffraction grating. In the example shown in FIG. 10B, the bottom of the groove 1005 is formed by an intersection of the first and second sloping portions 1007, 1009 of two adjacent peaks 1003. The first sloping portion 1007 is on one of the adjacent peaks 1003 and the second sloping portion 1009 is on the other adjacent peak. Similarly, the top of the peak 1003 is formed by an intersection of the first and second sloping portions 1007, 1009 at the top of the peak 1003. Other configurations, however, are possible. For example, the first and second sloping portions may not necessarily intersect, for example, if the bottom of the groove 1005 has a flat base or if the top of the peak 1003 includes a flat plateau as will be discussed below. The blazed diffraction grating 1008 has a line spacing or pitch, d, which may be constant in some implementations. This line spacing or pitch, d, may be a measure, for example, of the separation the apexes of the peaks 1003 in the grating 1008 having a similar shape as that shown in FIG. 10B. Similarly, the line spacing or pitch, d, may be a measure of the separation of the deepest location of adjacent grooves 1005. The line spacing or pitch, d, may be measured from other positions on the grating features.

The slopes can be tilted at an angle, δ, with respect to a plane parallel to the surface of the grating 1008 or waveguide (e.g., the surface 1004S of the waveguide, which may extend beyond the grating or the surface 1004S′ of the waveguide opposite the grating of FIG. 10A). This angle, δ, of the first (shallower) sloping portion 1007 may be referred to herein as the blaze angle.

As illustrated in FIG. 10B, the blazed diffraction grating 1008 can include grating lines or features that have asymmetric shape, for example, that comprise asymmetrically shaped peaks 1003 and/or grooves 1005. For example, in the diffraction grating shown in FIG. 10B, the diffraction features comprise peaks 1003 and/or grooves 1005 having an asymmetrical triangular cross-sectional shape. As discussed above, this asymmetric shape results in the different inclinations and/or widths of the first and second sloping portions 1007, 1009. Other shapes, however, are possible.

In designs where the diffraction features are asymmetric, for example, where the inclination of the first sloping portion is shallower while the slope of the second sloping portion is steeper, the diffraction features may be considered to be formed from repeating slopes and steps. Such structures may be referred to herein as a tilted step structure. In some implementations, the second portion may be so steep as to not slope; for example, the second portion may be parallel to the normal 1002.

In other implementations of the “sawtooth” pattern, however, the peaks 1003 and/or grooves 1005 may be symmetric. For example, the first and second sloping portions 1007, 1009 may have the same inclination and be the same width.

The cross-section pattern shown in FIG. 10B may be referred to herein as a single-step geometry, in comparison to a multi-step structure, which are also possible.

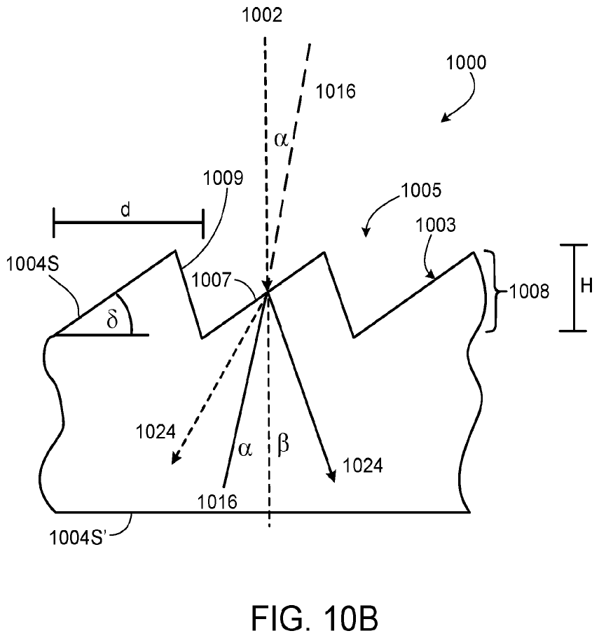

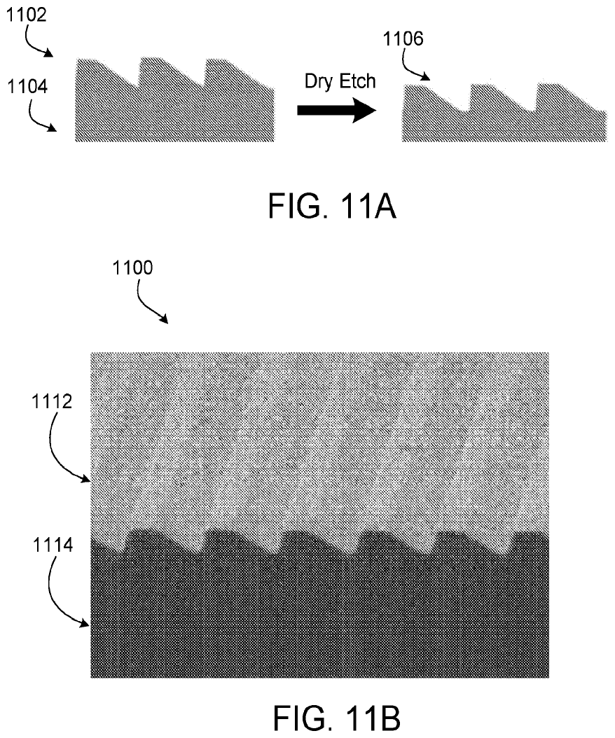

Regardless of whether the diffraction features are asymmetric or symmetric, in some implementations, a plateau or flat portion may be located at the top of the peak 1003 as will be discussed below. Diffraction gratings 1008 comprising diffraction features having plateaus or flat portions on top of the peaks 1003 are shown, for example, in FIG. 11B.

FIG. 10B shows an incident light beam 1016 incident on the grating 1008 at an angle α with respect to the normal direction 1002. (As discussed above with regard to FIG. 10A, the light can pass through the substrate or waveguide 1004 and be incident on the diffraction grating 1008 from the other side in other examples.) As discussed above, the normal 1002 is normal or orthogonal to the extended surface of the blazed diffraction grating 1008 or the plane of the grating or waveguide and/or the surface 1004S of the waveguide 1004, for example, a major surface of the waveguide on which the grating is formed or the opposite planar surface 1004S′. In FIG. 10B, the light 1016 incident on the diffraction grating 1008 is shown as diffracted at an angle β with respect to the normal direction 1002.

When configured as an in-coupling optical element or an in-coupling diffraction grating, the diffraction grating 1008 can diffractively couple light incident into the substrate 1004, which can be a waveguide as described above. The diffraction grating 1008 may, if desired, be configured as an out-coupling optical element and, in such embodiments, can diffractively couple light from the substrate 1004, which can be a waveguide also as described above.

Referring to FIGS. 10A and 10B, in some implementations, the substrate 1004 comprises a high index material having an index of refraction of at least 1.9. The index of refraction, for example, can be at least 2.0, at least 2.1, at least 2.2, or at least 2.3 and may be no more than 2.4, 2.5, 2.6, 2.7, 2.8, or may be in any range formed by any of these values or may be outside these ranges (e.g., 3.0 or more, such as up to 4.0). In some implementations, for example, the substrate comprises a Li-based oxide. In various examples disclosed herein, the diffractive features of the diffractive grating 1008 may be formed at a surface of the substrate 1004. The diffractive features may either be formed in the substrate 1004, e.g., a waveguide, or in a separate layer formed over the substrate 1004. e.g., a waveguide, and configured to optically communicate with the substrate 1004, e.g., couple light into or out of the substrate 1004. In the illustrated example, the diffractive features of the diffraction grating 1008 such as lines are formed in the substrate 1004 such as in the surface of the substrate. The diffractive features, for example, may be etched into the substrate 1004 comprising high index material such as a Li-based oxide. The substrate may, for example, comprise lithium niobate and the diffractive grating may be formed in the lithium niobate substrate by etching or patterning the surface of the substrate. Other materials having high refractive index may also be used. For example, other materials comprising lithium such as lithium oxides, e.g., lithium tantalate (LiTaO₃) may be employed as a substrate. Silicon carbide (SiC) is another option for the substrate material. Examples are not so limited. In other examples, the diffractive features of the diffractive grating 1008 may be formed in a separate laver disposed over. e.g., physically contacting, the substrate 1004. For example, a thin film coating of under 200 nm thickness of zinc oxide (ZnO), silicon nitride (Si₃N₄), zirconium dioxide (ZrO₂), titanium dioxide (TiO₂), silicon carbide (SiC), etc., may be disposed over an existing high index substrate. The thin film coating may be patterned to form the diffractive features. In some implementations, however, diffractive features, such as lines, of a diffraction grating 1008 may be formed of a material different from that of the substrate. The substrate may, for example, include a high index material such as a Li-based oxide (e.g., lithium niobate, LiNbO₃, or lithium tantalate, LiTaO₃), however, the diffractive features may be formed from a different material such as coatings of zinc oxide (ZnO), zirconium dioxide (ZrO₂), titanium dioxide (TiO₂), silicon carbide (SiC) or other materials described herein. In some implementations, this other material formed on the substrate may have a lower index of refraction. In some cases, the substrate 1004 can include, for example, materials (including amorphous high index glass substrates) such as materials based on silica glass (e.g., doped silica glass), silicon oxynitride, transition metal oxides (e.g., hafnium oxide, tantalum oxide, zirconium oxide, niobium oxide, aluminum oxide (e.g., sapphire)), plastic, a polymer, or other materially optically transmissive to visible light having, e.g., a suitable refractive index as described above, that is different from the material of the Li-based oxide features 1008.

However, as described above, in various implementations described herein, the diffraction gratings 1008 and the substrate 1004 or waveguide both comprise the same material, e.g., a Li-based oxide. In some implementations, the diffraction gratings 1008 are patterned directly into the substrate 1004, such that the diffraction gratings 1008 and the substrate 1004 form a single piece or a monolithic structure. For example, the substrate 1004 comprises a waveguide having the diffraction grating 1008 formed directly in the surface of the waveguide or substrate. In these implementations, a bulk Li-based oxide material may be patterned at the surface 1004S to form the diffraction gratings 1008, while the Li-based oxide material below the diffraction gratings 1008 may form a waveguide. In yet some other implementations, the bulk or substrate 1004 and the surface 1004S patterned to form the diffraction gratings 1008 comprise different Li-based oxides. For example, a bulk Li-based oxide material patterned at the surface region to form the diffraction gratings 1008 may be formed of a first Li-based oxide material, while the Li-based oxide material below the diffraction gratings 1008 that form the substrate 1004 or the substrate region may be formed of a second Li-based oxide material different from the first Li-based oxide material. As discussed above, in some other implementations, the diffraction gratings 1008 comprise of different high-index material such as zirconium dioxide (ZrO₂), titanium dioxide (TiO₂), silicon carbide (SiC), etc. and the material below the diffraction gratings 1008 that form the substrate 1004 or the substrate region may be formed of a second material such as LiTaO₃. LiNbO₃, etc. and different from the first material coated as a thin film.

In the illustrated example in FIGS. 10A and 10B, the diffraction grating 1008 may include a plurality of blazed diffraction grating lines that are elongated in a first horizontal direction or the y-direction and periodically repeat in a second horizontal direction or the x-direction. The diffraction grating lines can be, e.g., straight and continuous lines extending in the y-direction. However, embodiments are not so limited. In some implementations, the diffraction grating lines can be discontinuous lines, e.g., in the y direction. In some other implementations, the discontinuous lines can form a plurality of pillars protruding from a surface of the grating substrate. In some implementations, at least some of the diffraction grating lines can have different widths in the x-direction.

In the illustrated example, the diffraction grating lines of the diffraction grating 1008 have a profile, e.g., a sawtooth profile, having asymmetric opposing side surfaces forming different angles with respect to a plane of the substrate. However, embodiments are not so limited and in other implementations, the diffraction grating lines can have symmetric opposing side surfaces forming similar angles with respect to a plane of the substrate.

Referring to FIGS. 10A and 10B, according to various embodiments, the diffraction gratings 1008 may have various dimensions. For example, the diffractive features of the diffraction gratings 1008 may have a height (H) of 10 nm or 40 nm to 150 nm or 200 nm, 50 nm to 110 nm, 60 nm to 100 nm, 70 nm to 90 nm, or about 80 nm or a height in a range defined by any of these values, according to embodiments. This height may correspond to the height of the peaks 1003 and/or the depth of the grooves 1005. Such heights with a blaze geometry in high index material may provide a diffraction grating with reduced polarization sensitivity. Other heights, however, might be possible.

The diffraction gratings 1008 may have a pitch of 250 nm to 350 nm, 300 nm to 400 nm, 250 nm to 450 nm, or a pitch in any range defined by any of these values, according to various embodiments. Other pitches are also possible.

In some embodiments, the diffraction gratings 1008 may have blaze angles of about 20 to 89 degrees and anti-blaze angles of 70 to 150 degrees or any value in a range defined by these values. Values outside these ranges, as discussed below, are also possible.

In general, blazed diffraction gratings of either single-step or multi-step geometry are possible, and a variety of techniques can be used to form the gratings. In the example shown in FIGS. 11A-11B, gratings can be formed by depositing blazed photoresist and then etching and patterning the photoresist.

Example methods of forming blazed gratings and examples of various blazed grating geometries are described in US20210072437A1, entitled “Display device with diffraction grating having reduced polarization sensitivity,” the entire contents of which are incorporated herein by reference.

FIG. 11A illustrates the formation of a single step blazed grating 1106 in a substrate 1104, which may be a waveguide 1004 (FIG. 10A). A patternable material such as photoresist 1102 is deposited onto a substrate 1104, which be or include a waveguide 1104. The patternable material/photoresist 1102 is patterned to have a shape of the blazed grating. Forming a blazed geometry in the photoresist 1102 may, in some implementations, involve imprinting a pattern such as a single step “sawtooth” pattern in the photoresist 1102 (e.g., depositing photoresist on the substrate 1104 and then imprinting the blazed geometry). The photoresist 1102 may comprise a mask such as a hard mask. The patterned photoresist 1102 and the substrate 1104 may then be etched to form a blazed pattern in substrate 1106. Etching the photoresist 1102 and the substrate 1104 may involve a dry plasma or chemical etch and/or a wet chemical etch, for example. In some implementations, the etching illustrated in FIG. 11A may etch away material at a relatively constant rate, such that portions where the patterned photoresist was the thickest result in a relatively smaller amount of removal. e.g., negligible or no removal, of the material from the substrate, while portions where the patterned photoresist was the thinnest (or non-existent) result in a relatively large amount of removal of the material from the substrate or the deepest etches into the substrate.

FIG. 11B is a scanning electron micrograph of a blazed photoresist grating 1112, wherein a blazed grating pattern is formed in a photoresist 1104, for example by imprinting the photoresist with a patterned master. The diffraction grating 1112 shown has a single-step blazed geometry.

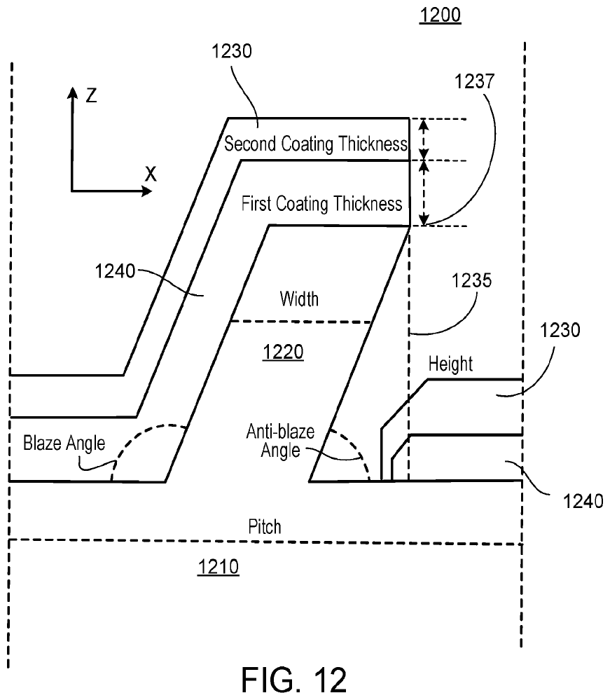

In some examples, blazed gratings have parallel side walls. Such gratings can also be referred to as “slanted gratings.” For example, referring to FIG. 12, a cross-sectional profile for one pitch length for such a grating is shown in which a grating structure 1200 includes a grating layer composed of ridge 1220 on a substrate 1210. A Cartesian coordinate system is provided for reference. The grating extends in the x-direction and the ridge 1220 extends from a base portion in the z-direction, with opposing slopes both angled with respect to the top surface of ridge 1220 and the substrate surface. Two additional layers 1230 and 1240 are formed on the surface of the grating layer. Layers 1230 and 1240 are formed on a top surface of ridge 1220 and in the valleys between successive ridges, but only one slope of ridge 1220 (in this case, the left hand side) is coated, while the other slope remains substantially free of these layers. Layers 1230 and 1240 can be formed using directional deposition methods (e.g., evaporation, glancing angle deposition). The asymmetric coating of the two ridge slopes can result from the directional deposition and the self-shadowing that occurs as a result.

The grating design shown in FIG. 12 can be characterized by, among other things, six geometrical parameter and three materials. Depending on the illumination wavelength and the desired response these parameters can vary in the following ranges:

TABLE 1
Parameter ranges for grating 1200

| Parameter | Range |
|---|---|
| Anti-blaze Angle | 95°-165° |
| Height | 10 nm-1000 nm |
| Pitch | 100 nm-5,000 nm |
| Duty Cycle (Width/Pitch) | 5%-95% |
| First Coating Thickness | 5 nm-500 nm |
| Second Coating Thickness | 5 nm-500 nm |

As depicted in FIG. 12, the anti-blaze angle refers to an acute angle between the right-hand slope of ridge 1220 and the base surface. The anti-blaze angle can in a range from 75° 25 to 165° (e.g., 75° to 150°, 80° to 140°, 85° to 130°, 90° to 120°, 90° to 100°, 100° to 160°, 120° to 160°, 1300° to 150°, 135° to 140°).

The blaze angle refers to an angle between the left-hand slope of ridge 1220 and the base surface. For the geometry depicted in FIG. 12, a slanted grating, this angle is the compliment of the anti-blaze angle (i.e., 180° minus the blaze angle). This angle can be in a range from 20° to 85° (e.g., 20° to 80°, 20° to 70°, 20° to 60°, 20° to 50°, 25° to 50°, 25° to 45°, 30° to 40°).

The height of the grating layer refers to the ridge dimension along the z-direction. The ridge 1220 can have a height in a range from 10 nm to 1.000 nm (e.g., 50 nm to 500 nm, 100 nm to 400 nm, 200 nm to 400 nm, 250 nm to 350 nm).

The pitch of the grating layer is the dimension along the x-direction between adjacent ridges or adjacent valleys. In general, the pitch, like the other parameters for grating structure 1200, can be determined empirically and/or through simulations. The pitch can be adjusted according to the operative wavelength(s) for the grating. In general, the pitch is in a range from 100 nm to 5,000 nm (e.g., 100 nm to 2,500 nm, 100 nm to 1,000 nm, 200 nm to 750 nm, 250 nm to 500 nm, 300 nm to 400 nm, 200 nm to 500 nm, 250 nm to 450 nm, 300 nm to 400 nm, 325 nm to 375 nm, 350 nm to 370 nm).

The ridges have a width, which refers to the dimension along x-direction. For grating structure 1200, the opposing slopes of ridge 1220 through the cross-section illustrated are parallel, so the ridge thickness is constant for the ridge through its height. However, it is possible in certain implementations for the width to vary (e.g., narrow) from the base of the ridge to the top. In embodiments where the width varies, the width can be determined at the midpoint of the ridge's height.

The top width of a ridge refers to the width of a ridge at the top of the grating layer, as shown in FIG. 12. In examples, the top width can be in a range from 50 nm to 150 nm (e.g., 60 nm to 140 nm, 70 nm to 130 nm, 80 nm to 100 nm).

The duty cycle refers to the ratio of the width to the pitch, expressed as a percentage. In embodiments, the grating structure can have a duty cycle in a range from 5% to 95% (e.g., 10% to 75%, 20% to 50%, 30% to 40%).

The ridge has a height corresponding to the dimension of the ridge in the z-direction, measured from its' base to its' top surface. The ridges can have a height in a range from 10 nm to 1,000 nm (e.g., 50 nm to 500 nm, 100 nm to 400 nm, 200 nm to 400 nm, 250 nm to 350 nm).

The thickness of the layers 1230 and 1240 refer to the dimension of the layers in the z-direction measured at a point where the surface supporting the layer is perpendicular to the z-direction. The first layer 1230 and/or second layer can have a thickness in a range from 5 nm to 500 nm (e.g., 10 nm to 400 nm, 20 nm to 300 nm, 50 nm to 250 nm, 100 nm to 200 nm, 130 nm to 170 nm). Generally, the thickness of the first and second layer can be the same or different.

The base material of the grating structure (i.e., substrate 1210 and ridge 1220) can be a UV or Thermally crosslinked polymer. The refractive index of the base material can be in a range from 1.5 to 2.2 (e.g., 1.6 or more, 1.7 or more, 1.8 or more, 1.9 or more, 2.1 or more, such as up to 2.2). High refractive indexes (e.g., 1.8 or more) can be achieved using polymeric composite materials, e.g., that include nanoparticles (e.g., high index nanoparticles, e.g., TiO₂ nanoparticles and/or ZrO₂ nanoparticles).

Without wishing to be bound by theory, it is believed that higher index of the base patterned material can help make the diffraction efficiency similar over larger angles.

In some embodiments, the first coating 1240 is composed of a material having a high refractive index (e.g., 1.8 or more). The first coating 1240 can be formed from a dielectric material including, but not limited to, titanium dioxide, gallium phosphide, and silicon carbide.

In certain embodiments, the second coating 1230 is composed of a material having a low refractive index dielectric (e.g., 1.6 or less, 1.5 or less, 1.45 or less). The second coating can be formed, for example, from a dielectric material such as (but not limited to) silicon dioxide, magnesium fluoride, and calcium fluoride.

In general, the grating layer of grating structure 1200 and similar grating structures can be formed using the techniques described herein and in US20210033867A1 and US20210072437, the entire contents both of which are incorporated herein by reference.

First coating 1230 can be formed using a variety of physical vapor deposition techniques, including but not limited to sputtering and e-beam deposition. Second coating 1240 can be formed by a variety of physical vapor deposition techniques, including but not limited to sputtering and e-beam deposition. In general, the technique used to form coating 1230 can be the same or different as the technique used to form coating 1240.

Optical performance of an example grating structure as described in FIG. 12 above was simulated using rigorous coupled wave analysis (RWCA) as follows. Parameter values for the grating structure were:

TABLE 2
Parameter and values for example ICG
for operation at green wavelengths

| Parameter | Value | |
|---|---|---|
| Anti-blaze Angle | 110° | |
| Height | 260 | nm |
| Pitch | 382 | nm |
| Duty Cycle (Width/Pitch) | 40% | |
| First Coating Thickness (TiO₂) | 120 | nm |
| Second Coating Thickness (MgF₂) | 70 | nm |

For purposes of the simulation, an operative wavelength of 525 nm was used and the base material had a refractive index of 2.0.

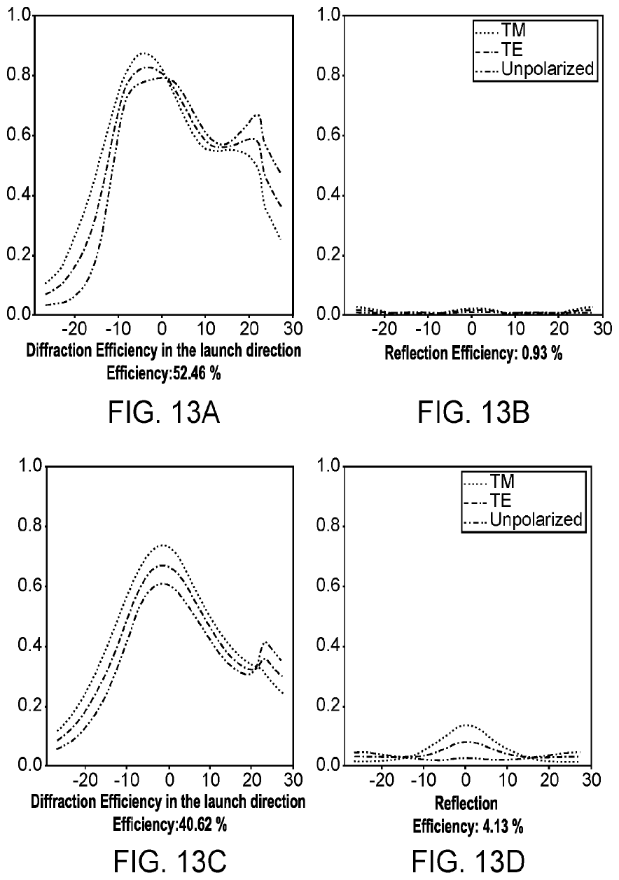

FIG. 13A shows diffraction efficiency in the launch direction as a function of illumination angle for the simulated grating over a field of view of 55°. The three curves correspond to TM polarized light, TE polarized light, and unpolarized light. A diffraction efficiency of 52.46% was calculated. FIG. 13B shows reflection efficiency as a function of illumination angle for the simulated grating for TM polarized light, TE polarized light, and unpolarized light. A reflection efficiency of 0.93% was calculated. FIGS. 13C and 13D correspond to the same plots as shown in FIGS. 13A and 13B, respectively, simulated for the same structure except without the second layer. The diffraction efficiency is still high, but back reflection increases significantly.

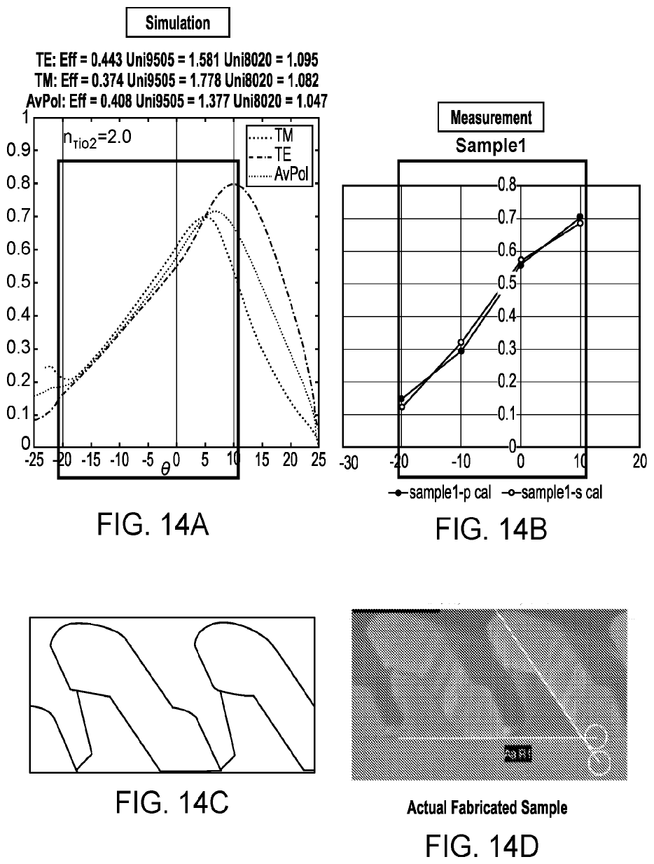

Additional experiments were performed to compare the results of simulated grating structures to measurements of similar fabricated samples. Results of these experiments are shown in FIGS. 14A-14D. Specifically. FIGS. 14A and 14B show plots of diffraction efficiency as a function of incidence angle over a range of incidence angles for TM, TE, and unpolarized light. FIG. 14A shows simulated data, while FIG. 14B shows measurements of the fabricated sample of a subset of the simulated range. FIGS. 14C and 14D show a schematic of the cross-section profile for this grating structure (FIG. 14C) and an SEM of the cross-section of the fabricated sample (FIG. 14D).

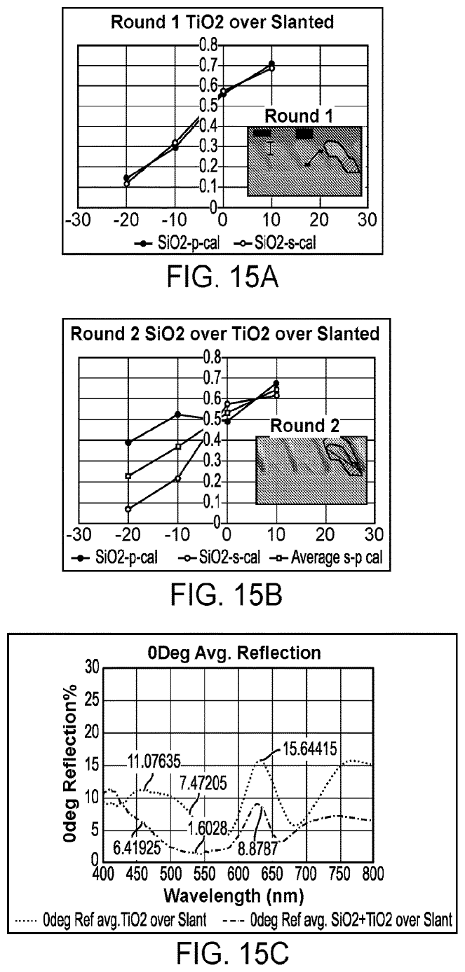

FIGS. 15A-15C illustrate the effect of including a low index layer as the topmost layer in a grating structure. FIG. 15A is a plot of diffraction efficiency as a function of incident angle for orthogonal polarization states for a grating structure that has a coating of TiO₂ thereon. An SEM of the cross-sectional profile of the grating structure is shown in the inset. FIG. 15B is a plot of diffraction efficiency as a function of incident angle for the same grating structure except for a further layer of SiO₂ formed over the TiO₂ layer. Average diffraction efficiency is shown along with the diffraction efficiency for both s- and p-pol. FIG. 15C shows a plot of reflection for normally incident light as a function of wavelength for the visible light spectrum for the grating structure with and without the SiO2 coating. Reflection is lower across almost the entire visible spectral range.

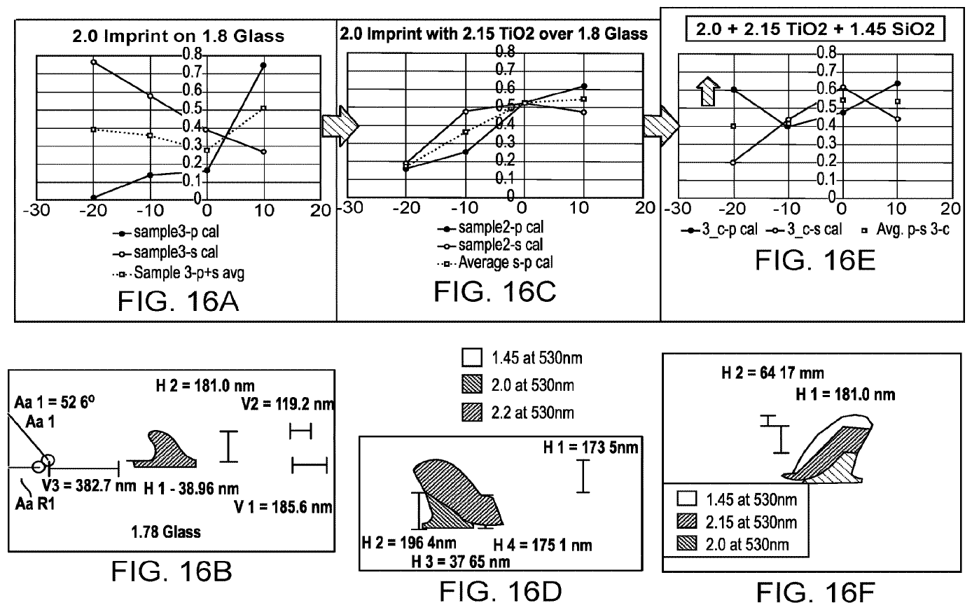

Measurements from further examples are shown in FIGS. 16A-16F. Specifically, FIG. 16A is a plot of diffraction efficiency as a function of incident angle for the grating structure shown in the SEM in FIG. 16B composed of a high refractive index (n=2.0) composite on a glass substrate (n=1.78). FIG. 16C is a plot of diffraction efficiency as a function of incident angle for the grating structure shown in the SEM in FIG. 16D composed of the high refractive index (n=2.0) composite on the glass substrate (n=1.78) in which the grating layer is coated with TiO2 (n=2.15). FIG. 16E is a plot of diffraction efficiency as a function of incident angle for the grating structure shown in the SEM in FIG. 16F composed of the high refractive index (n=2.0) composite on the glass substrate (n=1.78) with TiO2 (n=2.15) coating, where a further coating of SiO2 (n=1.45) is coating on the TiO2 layer. It is evident that the overall diffraction efficiency is increased compared to the single coating, particularly at higher incident angles.

While the foregoing example is of a slanted grating structure with a ridge that is a parallelogram in shape, more generally, other cross-sectional shapes are possible. For example, trapezoidal, triangular, and stepped shapes are also possible. Moreover, while the shape is depicted corresponding to the shape of a parallelogram with mathematical precision, deviations from these shapes is inevitable due to manufacturing limitations, etc. In general, as used herein, such a ridge and other features are considered to have a particular shape where either their design prescribes such a shape and/or the structure has such a shape within the capabilities of the processes used to manufacture such structures at scale.

Moreover, in some examples, ICGs can be designed to efficiently couple light (e.g., unpolarized light) at more than one wavelength (e.g., wavelengths spanning the visible spectrum, such as a red, a green, and a blue wavelength) into a waveguide. In some examples, an ICG can have a mean launch efficiency for unpolarized incident light at multiple wavelengths spanning a spectral range of 120 nm or more (e.g., 150 nm or more, 200 nm or more, 250 nm or more, e.g., 500 nm or less, 400 nm or less, 300 nm or less, 250 nm or less, e.g., from 400 nm to 800 nm, e.g., from 430 nm to 650 nm) of 40% or more (e.g., 45% or more, 50% or more, 55% or more, 60% or more, 65% or more, e.g., 75% or less, 70% or less, 65% or less, 60% or less, 55% or less) over a field of view of 10° or more (e.g., 15° or more, 200 or more, 22° or more, 25° or more, 30° or more, 40° or more, 500 or more, 600 or more 70° or more. e.g., up to 700 or less, 60° or less, 50° or less, 40° or less, 35° or less, 30° or less, 25° or less, 22° or less) in at least one direction (e.g., in two orthogonal directions, such as in a vertical direction and a horizontal direction).

In some examples, an ICG can be designed to have a relatively low back reflection of incident light (e.g., unpolarized light) at more than one wavelength (e.g., wavelengths spanning the visible spectrum, such as a red, a green, and a blue wavelength). For example, an ICG can have a mean back reflection for unpolarized incident light at multiple wavelengths spanning a spectral range of 120 nm or more (e.g., 150 nm or more, 200 nm or more, 250 nm or more, e.g., 500 nm or less, 400 nm or less, 300 nm or less, 250 nm or less, e.g., from 400 nm to 800 nm, e.g., from 430 nm to 650 nm) of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 100 or more (e.g., 15° or more, 20° or more, 22° or more, 250 or more, 300 or more, 40° or more, 50° or more, 60° or more 700 or more, e.g., up to 700 or less, 60° or less, 50° or less, 40° or less, 35° or less, 30° or less, 25° or less, 22° or less) in at least one direction (e.g., in two orthogonal directions, such as in a vertical direction and a horizontal direction).

In certain examples, an ICG can be designed to both efficiently couple light (e.g., unpolarized light) and have a relatively low back reflection of incident light (e.g., unpolarized light) at more than one wavelength. For example, an ICG can have, for unpolarized incident light at multiple wavelengths spanning a spectral range of 120 nm or more (e.g., 150 nm or more, 200 nm or more, 250 nm or more, e.g., 500 nm or less, 400 nm or less, 300 nm or less, 250 nm or less, e.g., from 400 nm to 800 nm, e.g., from 430 nm to 650 nm), a mean launch efficiency of 40% or more (e.g., 45% or more, 50% or more, 55% or more, 60% or more, 65% or more, e.g., 75% or less, 70% or less, 65% or less, 60% or less, 55% or less) and has a mean back reflection of 15% or less (e.g., 12% or less, 10% or less, 9% or less, 8% or less, 7% or less, 6% or less, 5% or less, 4% or less, 3% or less, e.g., 1% or more, 2% or more, 3% or more) over a field of view of 100 or more (e.g., 150 or more, 20° or more, 22° or more, 25° or more, 30° or more, 40° or more, 50° or more, 60° or more 70° or more, e.g., up to 70° or less, 600 or less, 500 or less, 400 or less, 350 or less, 300 or less, 25° or less, 22° or less) in at least one direction (e.g., in two orthogonal directions, such as in a vertical direction and a horizontal direction).

Without wishing to be bound by theory, it is believed that the inclusion of one or more dielectric layers over a grating layer of blazed ICGs can facilitate both the efficient coupling of light into a waveguide and the low back reflection. This performance is evident based on the following example ICG structures which were modeled via computer simulation. However, the structures described are examples and other structures are also possible. Generally, the structural parameters for a blazed grating can be optimized for a specific application empirically and/or using computational optimization methods.

An example slanted transmission grating with two dielectric layers has the following structure:

TABLE 3
parameters for example double coated slanted transmission grating

| Parameter | Value | |
|---|---|---|
| Pitch | 370 | nm |
| height | 339 | nm |
| Blaze angle | 68° | |
| Anti-blaze angle | 112° | |
| Duty cycle | 45% | |
| First coating thickness - TiO2 | 121 | nm |
| Second coating thickness - MgF2 | 38 | nm |

The grating ridges are formed from K21 resist and covered by a layer of TiO2, first, and a layer of MgF2, second.

Performance for this example was evaluated by calculating, for a unit cell of the grating structure, the 0^{th}, +1, and −1 diffraction efficiency for transmitted light at three different wavelengths (625 nm, 545 nm, 465 nm) for angles of incidence ranging from −45° to +45° for incident light with TM and TE polarization. For purposes of brevity, this analysis will be referred to as Metric I below.

Performance is also evaluated by calculating a launch efficiency into and a back reflection from a waveguide with a refractive index of 2.00, an aperture size of 2 mm×3.5 mm, and a waveguide thickness of 600 microns. The calculations are performed as a function of polarization state with respect to launch, where an angle of 0 corresponds to TM light and an angle of 90 corresponds to TE light. The calculations were also performed at three different wavelengths (625 nm, 545 nm, 465 nm). For purposes of brevity, this analysis will be referred to as Metric II below.

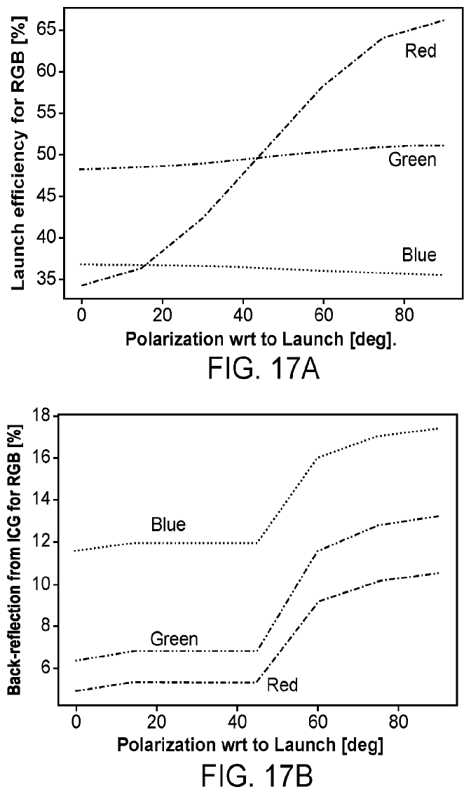

Metric II is shown for the example of Table 3 in FIGS. 17A and 17B. In particular, FIG. 17A shows launch efficiency (as a percentage) for incident light having polarization from 0° to 90°. FIG. 17B shows back reflection (as a percentage) for incident light having polarization from 0° to 90°.

In this example, based on the calculations for metric II, mean launch efficiency for the red, green, and blue light are 50.20%, 49.63%, and 36.26%, respectively. Mean reflection for the red, green, and blue light are 7.23%, 9.18%, and 13.95%, respectively.

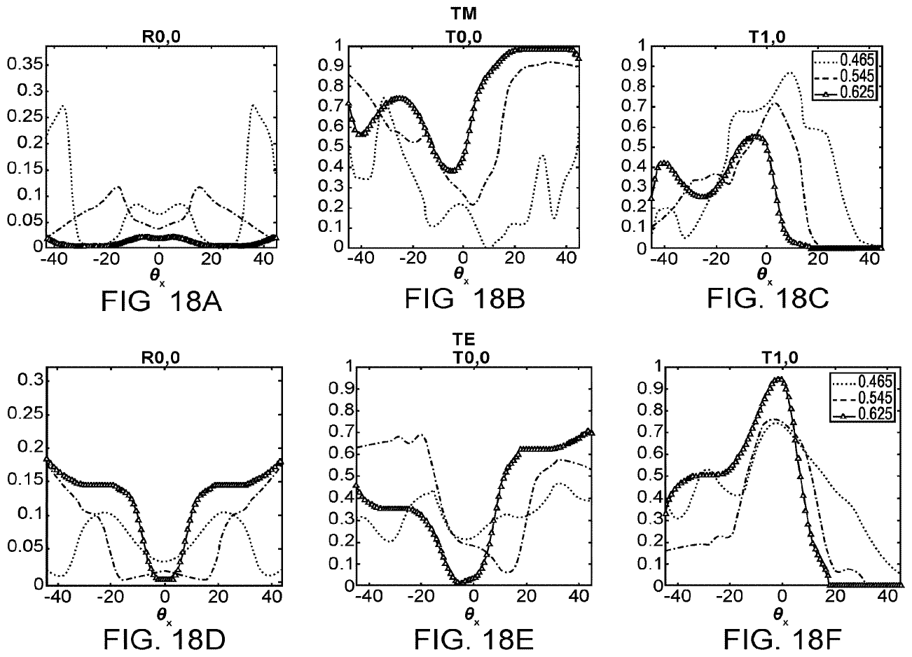

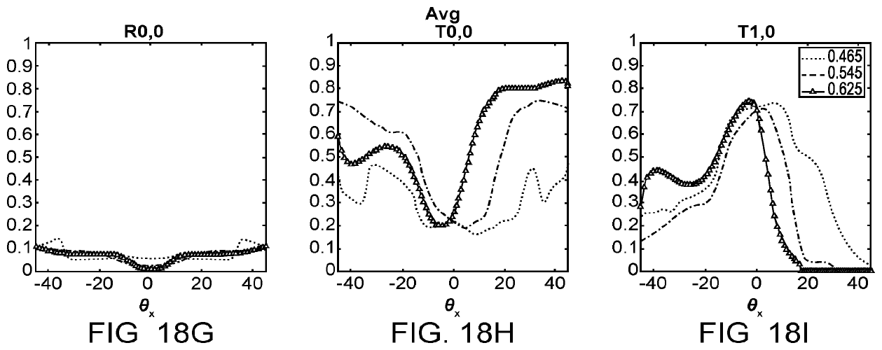

Metric I is shown for the example of Table 3 in FIGS. 18A-18I. FIGS. 18A-18C respectively show, for incident TM light, normalized zeroth-order reflectance as a function of incident angle, normalized zeroth-order transmission, and first-order transmission. First order transmission corresponds to light that his launched into the waveguide. FIGS. 18D-18F respectively show, for incident TE light, normalized zeroth-order reflectance as a function of incident angle, normalized zeroth-order transmission, and first-order transmission. FIGS. 18G-18I respectively show, for incident light averaged over TM and TE polarization, normalized zeroth-order reflectance as a function of incident angle, normalized zeroth-order transmission, and first-order transmission.

Another example of a blazed transmission grating with two dielectric layers has the following structure:

TABLE 4
parameters for example double coated blazed transmission grating

| Parameter | Value | |
|---|---|---|
| Pitch | 370 | nm |
| Top width | 103 | nm |
| Bottom width | 60 | nm |
| Blaze angle | 85° | |
| Anti-blaze angle | 50° | |
| First coating thickness - TiO2 | 165 | nm |
| Second coating thickness - MgF2 | 150 | nm |

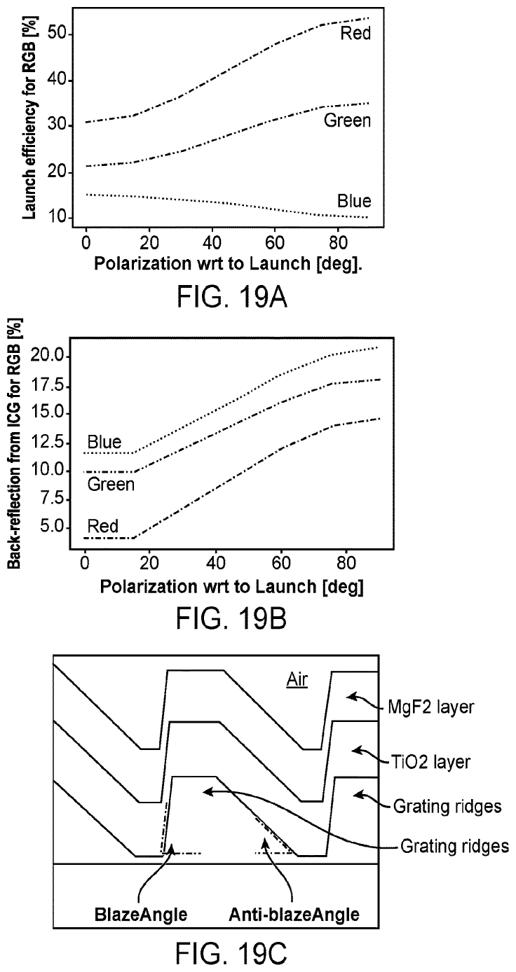

Metric II is shown for the example of Table 4 in FIGS. 19A and 19B. In particular, FIG. 19A shows launch efficiency (as a percentage) for incident light having polarization from 0° to 90°. FIG. 19B shows back reflection (as a percentage) for incident light having polarization from 0° to 90°. A cross-sectional view of the double coated blazed transmission ICG is shown in FIG. 19C.

In this example, based on the calculations for metric II, mean launch efficiency for the red, green, and blue light are 42.19%, 28.01%, and 12.64%, respectively. Mean reflection for the red, green, and blue light are 9.23%, 13.92%, and 16.08%, respectively.

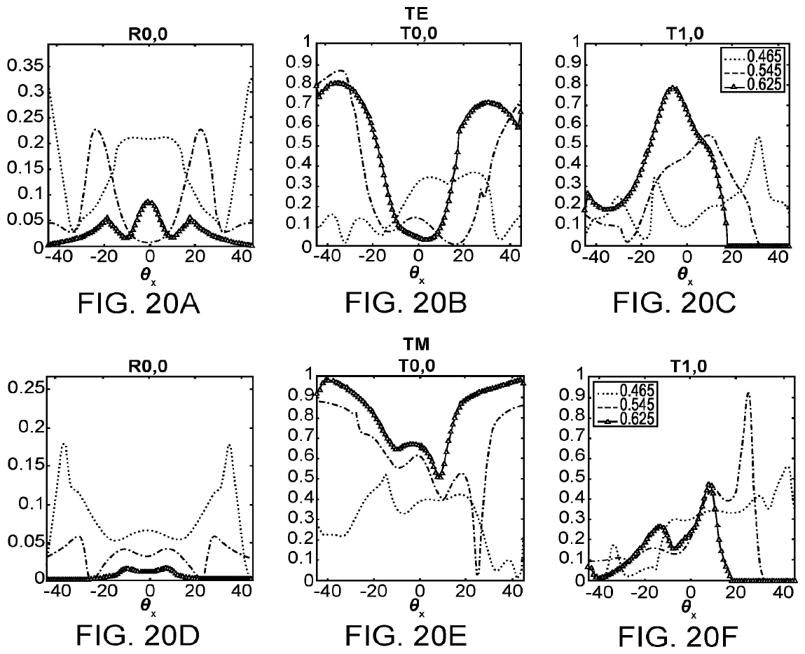

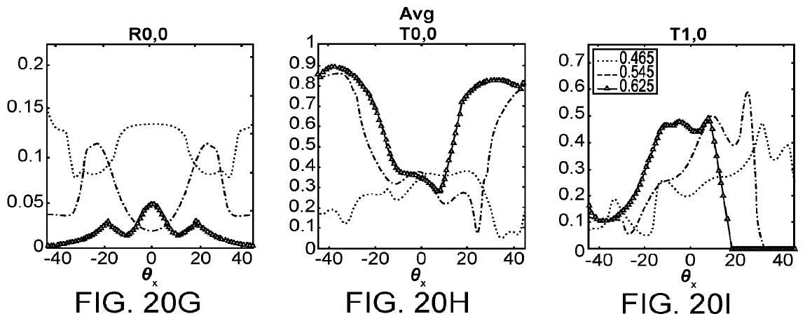

Metric I is shown for the example of Table 4 in FIGS. 20A-20I. FIGS. 20A-20C respectively show, for incident TM light, normalized zeroth-order reflectance as a function of incident angle, normalized zeroth-order transmission, and first-order transmission. First order transmission corresponds to light that his launched into the waveguide. FIGS. 20D-20F respectively show, for incident TE light, normalized zeroth-order reflectance as a function of incident angle, normalized zeroth-order transmission, and first-order transmission. FIGS. 20G-20I respectively show, for incident light averaged over TM and TE polarization, normalized zeroth-order reflectance as a function of incident angle, normalized zeroth-order transmission, and first-order transmission.

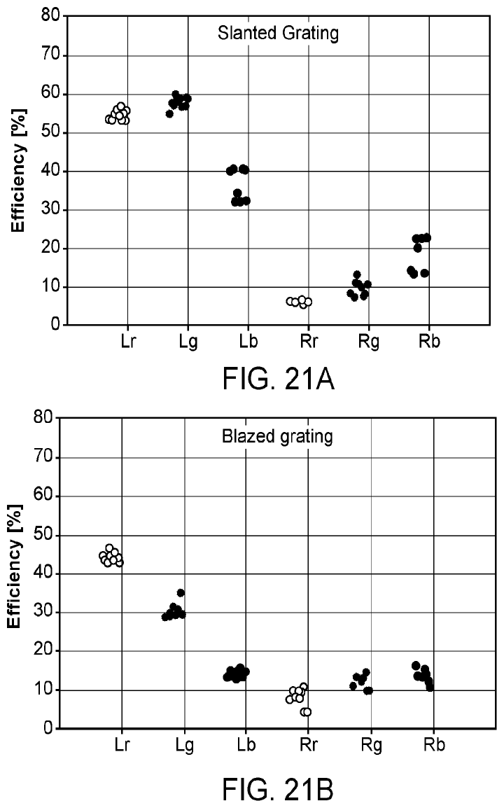

Referring to FIGS. 21A and 21B, the sensitivity analysis of launch efficiency and back-reflection performance for double coated slanted (Table 3) and blazed (Table 4) ICGs with respect to random design perturbation (+/−10 nm) in grating parameters was evaluated by further calculations. In these plots, Lr, Lg, Lb indicate the launch efficiency values for red, green, and blue wavelengths, respectively, and Rr, Rg, Rb indicate the back-reflection values for red, green and blue wavelengths, respectively, averaged over all angles within the field of view of illumination (˜30 deg, diagonal for the purpose of these calculations).

It is believed, based on these calculations, that slanted gratings (e.g., Table 3) may have more sensitivity to perturbations of grating dimensions than blazed gratings (e.g., Table 4). In other words, from large-scale manufacturability perspective, this implies that the fabrication of double coated blazed ICG gratings may not need higher precision on dimensions and thickness of layers as those demanded for manufacturing of slanted gratings.

### Reflection ICGs

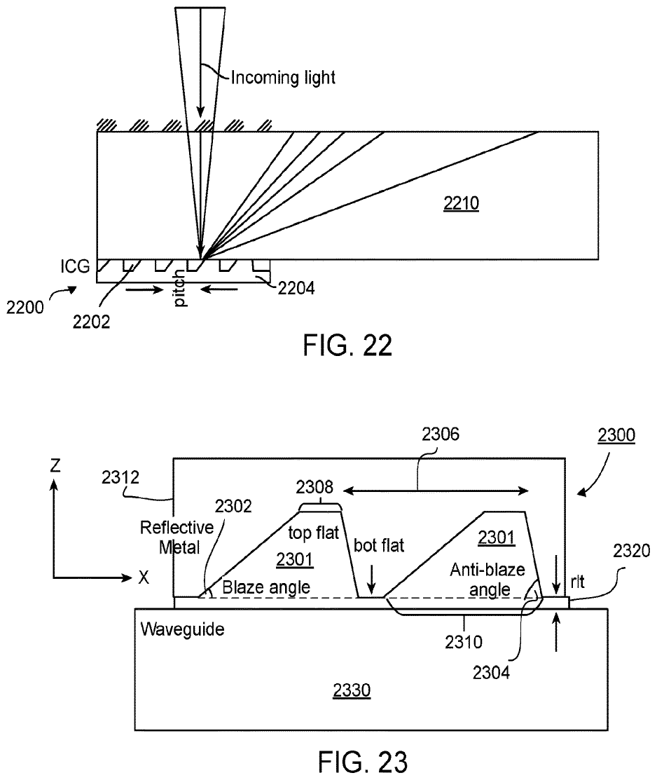

Furthermore, while the foregoing examples include ICGs that are transmission gratings for launching lighting into a waveguide, reflection gratings are also possible. As referred to here, a reflection ICG is an ICG which launches light into a waveguide via a reflective diffraction order, e.g., R₁₀. Referring to FIG. 22, an example of a reflective ICG 2200 for a single layer RGB waveguide 2210 includes a blazed grating 2202 covered by a reflective material 2204, such as a reflective metal (e.g., Al, Au, Ag, or alloys thereof).

The structure of an example blazed reflection grating 2300 is shown in FIG. 23. Here, parameters such as the blaze angle 2302, anti-blaze angle 2304, pitch 2306, top width 2308, and bottom width 2310 are the same as those described above with respect to the slanted grating shown in FIG. 12. “rlt” refers to a thickness (z-direction) of a continuous layer 2320 of the material (e.g., a polymer, such as a polymer resist) forming the grating ridges 2301 between the ridges and the top of the waveguide 2330.

A layer 2312 of a metal is formed over the ridges. The metal fills in the space between the ridges, conforming to the shape of the ridges.

A first example of a reflection grating is parametrized as follows:

TABLE 5
example of a metalized blaze grating

| Parameter | Value | |
|---|---|---|
| Top width | 100 | nm |
| Bottom width | 60 | nm |
| Pitch | 370 | nm |
| Blaze angle | 28 | |
| Anti-blaze angle | 85 | |
| rlt | 20 | nm |

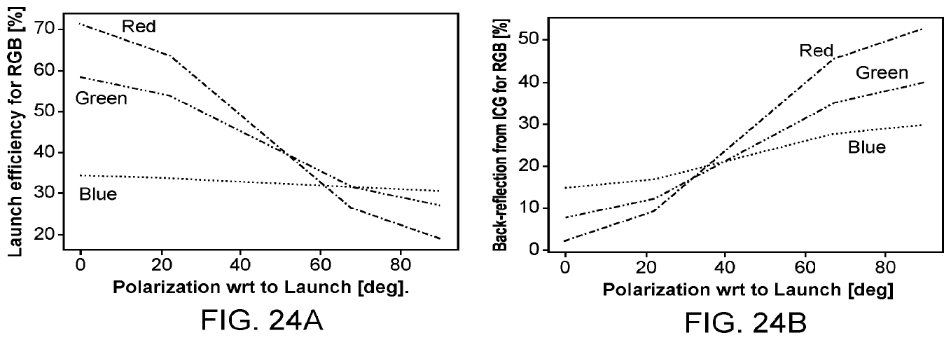

Metric II for the example metalized blaze grating of Table 5 are shown in FIGS. 24A and 24B. As shown, the launch efficiency and back reflection values or optimized for TM polarization while increasing/decreasing respectively for TE polarization. The average polarization mean reflection across FoV (22 deg×22 deg) by using an elliptical beam of (2 mm×3.5 mm) for RGB wavelengths are 27.43%, 32.62% and 22.14%, respectively. Furthermore, the launched light for average polarization into the waveguide are 44.94%, 42.59%, and 32.32%, respectively.

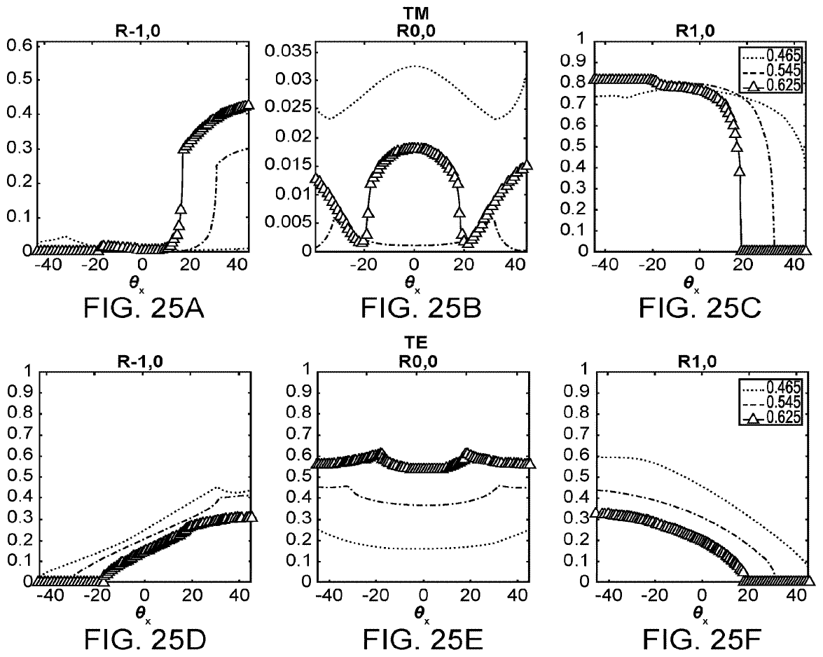

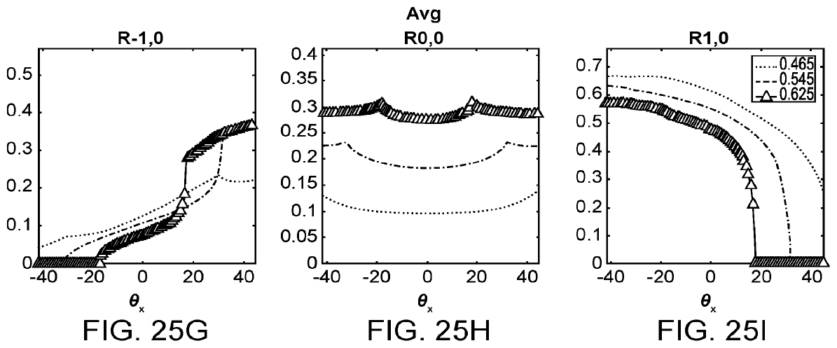

Metric I for the example metalized blaze grating of Table 5 are shown in FIGS. 25A-25I. Here, FIGS. 25A-25C show normalized reflection efficiency as a function of incident angle for TM polarized light reflected into the −1, 0, and +1 diffracted orders, respectively. The zeroth order reflection corresponds to back reflection and the +1 order corresponds to light launched into the waveguide. FIGS. 25D-25F show normalized reflection efficiency as a function of incident angle for TE polarized light reflected into the −1, 0, and +1 diffracted orders, respectively. FIGS. 25G-25I show normalized reflection efficiency as a function of incident angle averaged for TE and TM polarized light reflected into the −1, 0, and +1 diffracted orders, respectively. As can be seen from metric I results, the unit cell 0th order reflection values for TM polarization are below 5% for all colors while the values for TE polarization are close to ˜60%, ˜40% and ˜20% respectively for RGB.

A second example of a blazed reflection grating is summarized as follows:

TABLE 6
second example of a metalized blaze grating

| Parameter | Value | |
|---|---|---|
| Top width | 150 | nm |
| Bottom width | 64 | nm |
| Pitch | 370 | nm |
| Blaze angle | 31° | |
| Anti-blaze angle | 140° | |
| rlt | 20 | nm |

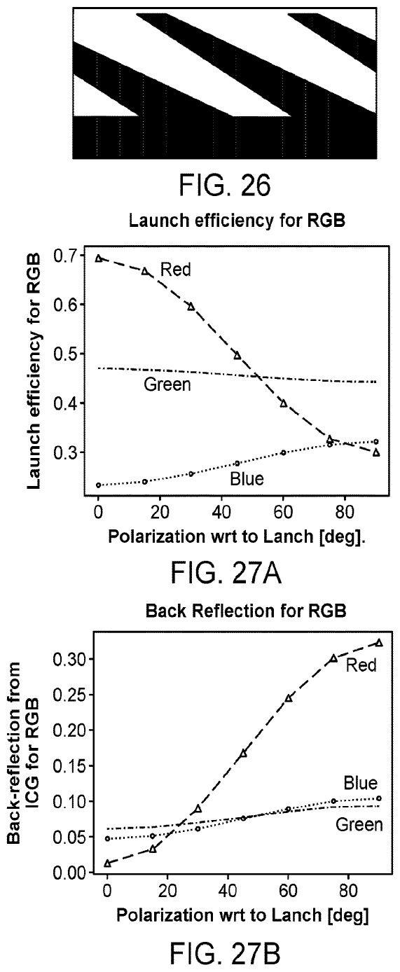

A profile shape for this example is shown in FIG. 26.

Metric II for the example metalized blaze grating of Table 6 are shown in FIGS. 27A and 27B. As can be seen in FIGS. 27A and 27B, the average polarization back reflection for all three colors (RGB) and significantly for green and red are reduced, for blue color it is not a sensible reduction in average polarization back reflection, while first order diffraction efficiency is lower. For the blue wavelength, although the first order diffraction efficiency is lower, the value is also reduced for −1 order, which is believed to be helpful for the phenomenon described before as multiple bouncing, which may result in reduced back reflection.

The average polarization mean reflection across FoV (22 deg×22 deg) by using an elliptical beam of (2 mm×3.5 mm) for RGB wavelengths are 16.74%, 7.73% and 7.53%, respectively. Furthermore, the launched light for average polarization into the waveguide are 49.74%, 45.65% and 27.82%, respectively.

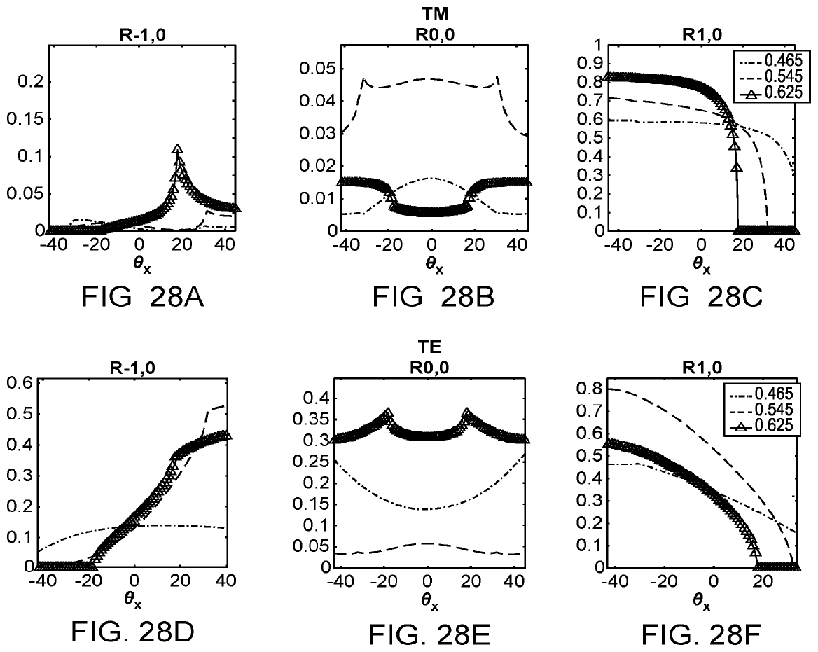

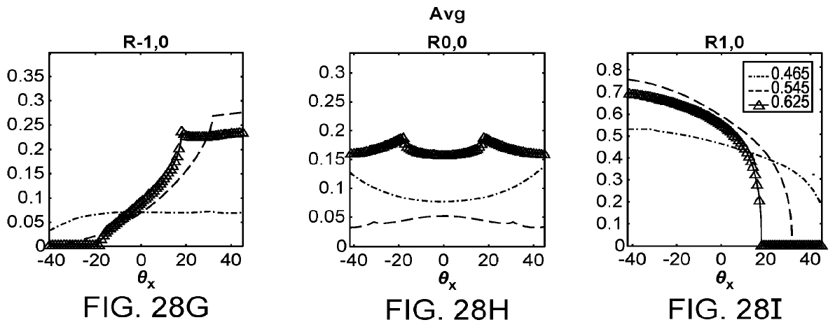

Metric I for the example metalized blaze grating of Table 6 are shown in FIGS. 28A-28I.

A further example of a blazed reflection grating is parameterized as follows:

TABLE 7
example of conformal coated blazed reflection grating

| Parameter | Value | |
|---|---|---|
| Top width | 81 | nm |
| Bottom width | 20 | nm |
| Pitch | 370 | nm |
| Blaze angle | 25 | |
| Anti-blaze angle | 90 | |
| Coating thickness - TiO2 | 87 | nm |
| rlt | 20 | nm |

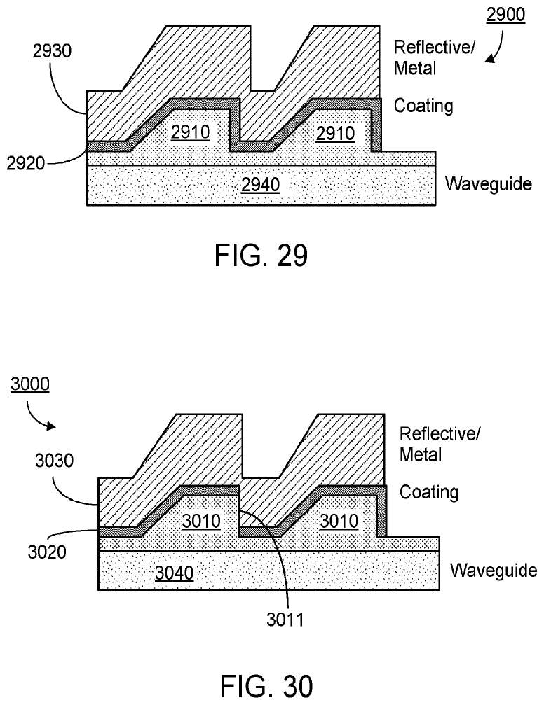

A cross-sectional profile 2900 for this example is shown in FIG. 29. Grating ridges 2910 are supported on a waveguide 2940. A TiO2 coating 2920 is conformal to the underlying ridges 2910 and is continuous across the grating layer. A reflective metal layer 2930 is coated over coating 2920.

Yet another example of a blazed reflection grating is parameterized as follows:

TABLE 8
example of directional coated blazed reflection grating

| Parameter | Value | |
|---|---|---|
| Top width | 96 | nm |
| Bottom width | 120 | nm |
| Pitch | 370 | nm |
| Blaze angle | 27 | |
| Anti-blaze angle | 91 | |
| Coating thickness - TiO2 | 95 | nm |
| rlt | 20 | nm |

A cross-sectional profile 3000 for this example is shown in FIG. 30. Grating ridges 3010 are supported on a waveguide 3040. A TiO2 coating 3020 is deposited in a directional process (e.g., a GLAD process) resulting in the ridge walls 3011 on the anti-blaze side of each ridge to be in the coating's shadow. As a result, the TiO2 layer 3020 is discontinuous across the grating layer.

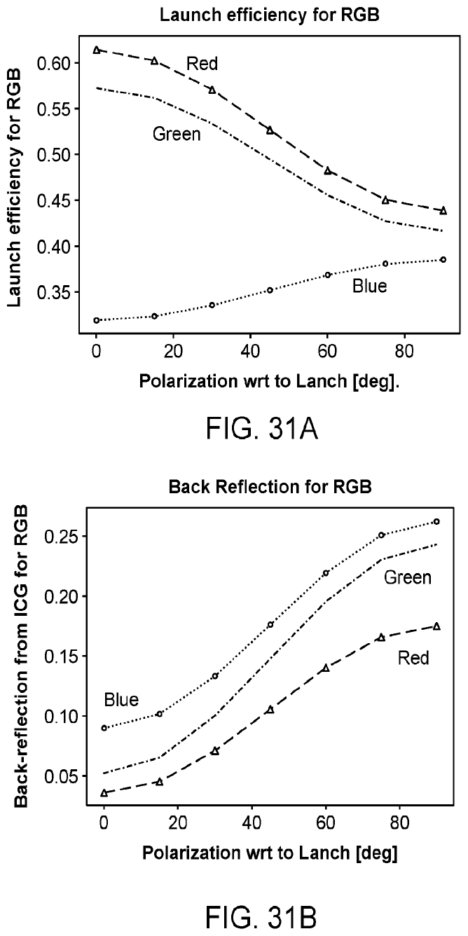

Metric II for the example metalized blaze grating of Table 8 are shown in FIGS. 31A and 31B. As can be seen in FIGS. 31A and 31B, the average polarization back reflection for all three colors (RGB) and significantly for green and red are reduced, for blue color it is not a sensible reduction in average polarization back reflection, while first order diffraction efficiency is lower. For the blue wavelength, although the first order diffraction efficiency is lower, the value is also reduced for −1 order, which is believed to be helpful for the phenomenon described before as multiple bouncing, which may result in reduced back reflection.

The average polarization mean reflection across FoV (22 deg×22 deg) by using an elliptical beam of (2 mm×3.5 mm) for RGB wavelengths are 10.57%, 14.76% and 17.63%, respectively. Furthermore, the launched light for average polarization into the waveguide are 52.63%, 49.40% and 35.23%, respectively.

As is evident from metric II, launch efficiency into the waveguide for all colors increases relative to the examples parameterized in Tables 5 and 6. The back reflection gets reduced for red, where in the case of large anti-blazed angle (e.g., Table 6), the TE polarization back reflection for red is still high in the range of 30%.

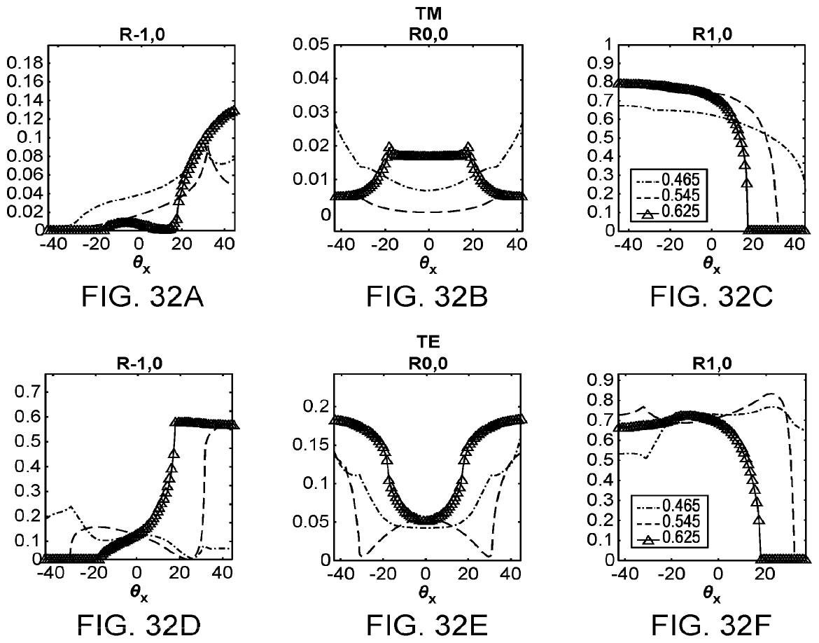

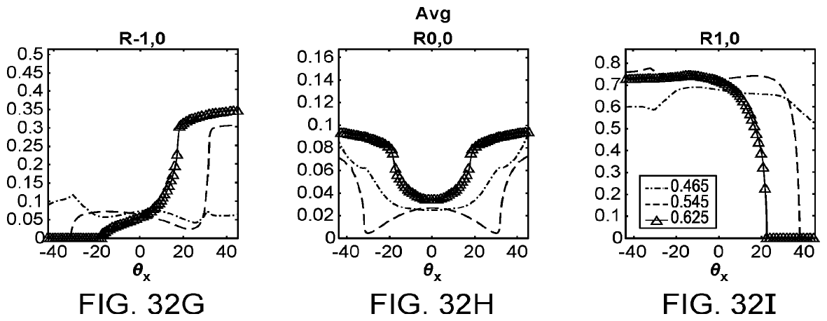

Metric I for the example metalized blaze grating of Table 8 are shown in FIGS. 32A-32I.

Parameters for an example two layer coated blazed grating are as follows:

TABLE 9
example of directional double coated blazed reflection grating

| Parameter | Value | |
|---|---|---|
| Top width | 72 | nm |
| Bottom width | 78 | nm |
| Pitch | 370 | nm |
| Blaze angle | 27° | |
| Anti-blaze angle | 92° | |
| First coating - TiO2 | 50 | nm |
| Second coating - SiO2 | 71 | nm |
| rlt | 20 | nm |

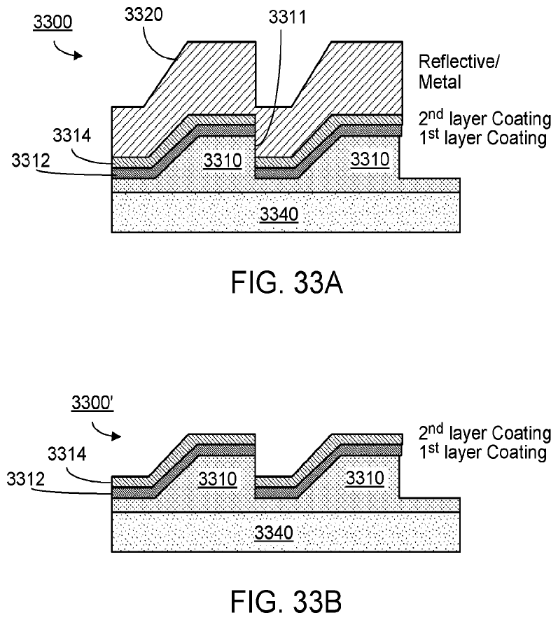

A cross-sectional profile 3300 for this example is shown in FIG. 33A. The grating includes ridges 3310 supported on a waveguide 3340. A 1^{st} layer coating 3310 is a TiO₂ coating and a 2^{nd} layer coating 3312 is a SiO2 coating. Both coatings 3312 and 3314 can be deposited in a directional process (e.g., a glancing angle deposition (GLAD)) resulting in the ridge walls 3311 on the anti-blaze side of each ridge to be in the coating's shadow. As a result, the two dielectric layers are discontinuous across the grating layer, specifically at the side wall 3311 at the anti-blaze side. A reflective layer 3320. e.g., metal layer, can be deposited using either a directional or isotropic deposition techniques (e.g., evaporation). In some examples, the dielectric layers can be deposited using isotropic deposition and then patterned to provide a discontinuous layer or layers (e.g., lithographically patterned).

While FIG. 33A shows an example of a reflection ICG, similar structures can be used for transmission ICGs too, such as shown in FIG. 33B, which shows a similar structure 3300′ but without a reflective layer.

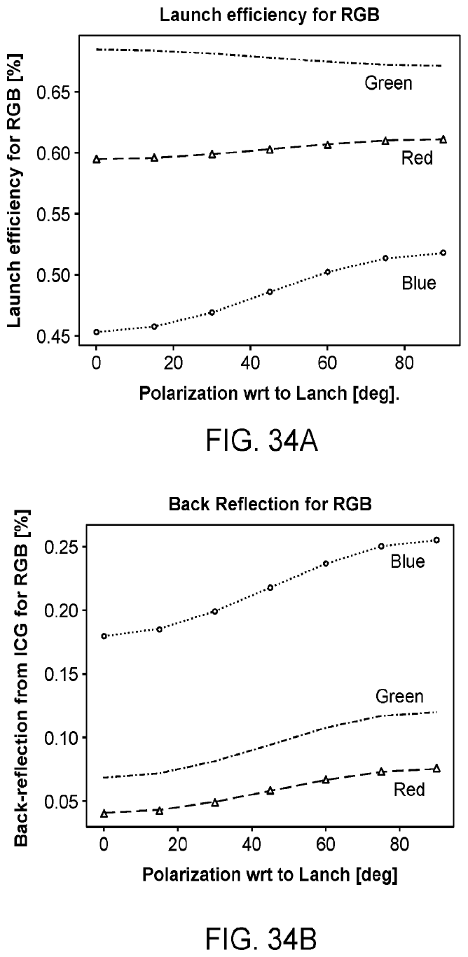

Metric II for the example metalized blaze grating of Table 8 are shown in FIGS. 34A and 34B. As can be seen in FIGS. 34A and 34B, the launch efficiency is largely polarization insensitive for the red and green wavelengths. For the blue wavelength, launch efficiency varies about 5% between TM and TE light. Back reflection varies by about 5% or less between TM and TE light for all three wavelengths.

The average polarization mean reflection across FoV (22 deg×22 deg) by using an elliptical beam of (2 mm×3.5 mm) for RGB wavelengths are 5.84%, 9.45% and 21.76%, respectively. Furthermore, the launched light for average polarization into the waveguide are 60.33%, 67.81% and 48.62%, respectively.

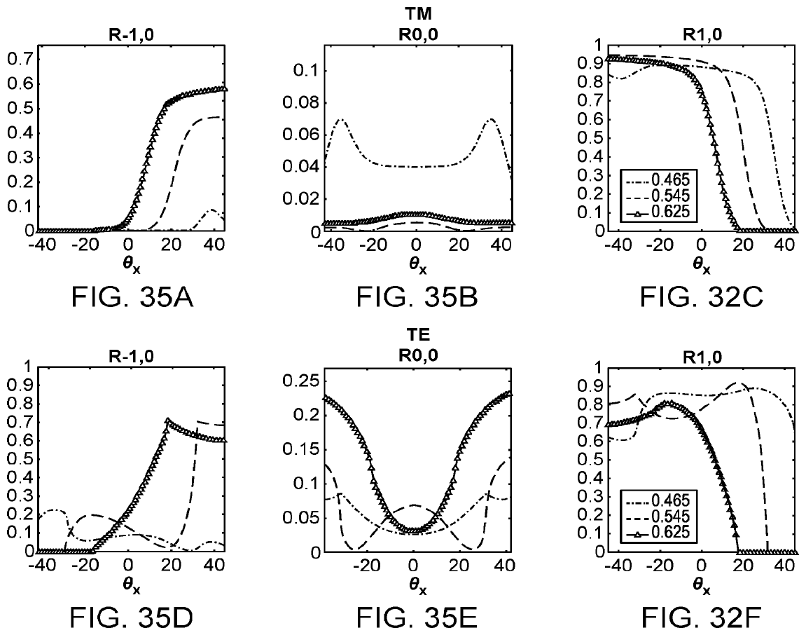

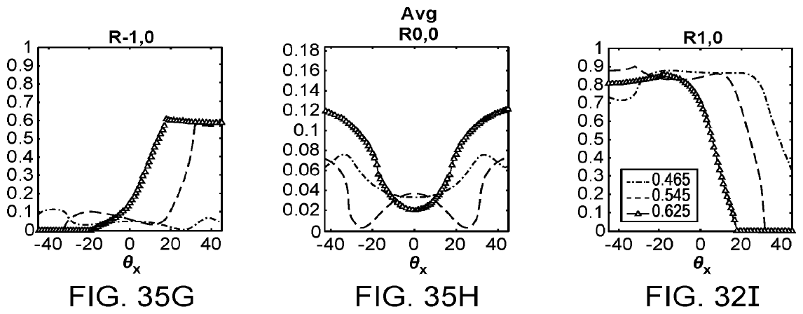

Metric I for the example metalized blaze grating of Table 8 are shown in FIGS. 35A-35I.

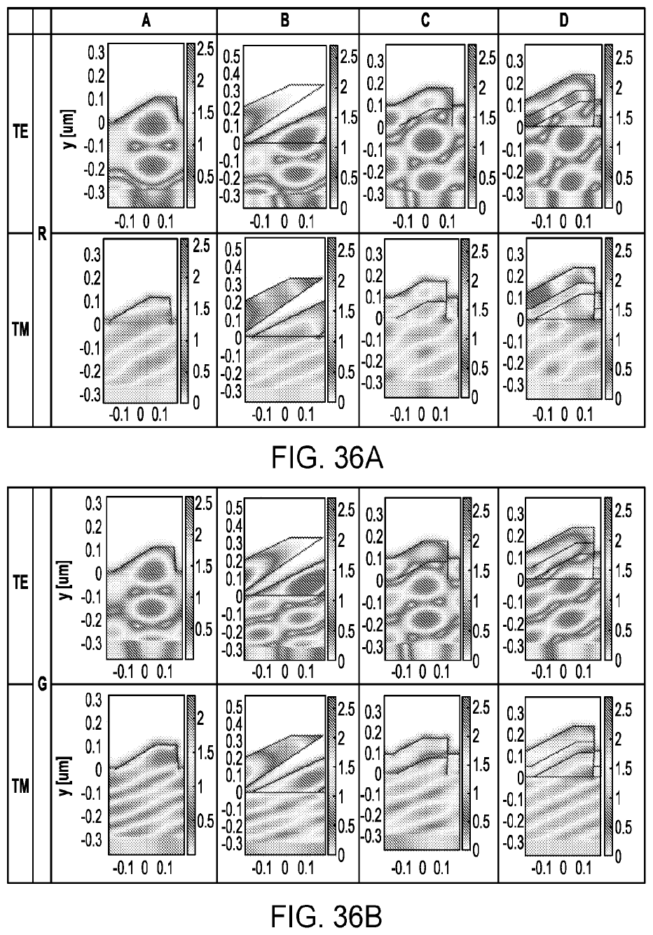

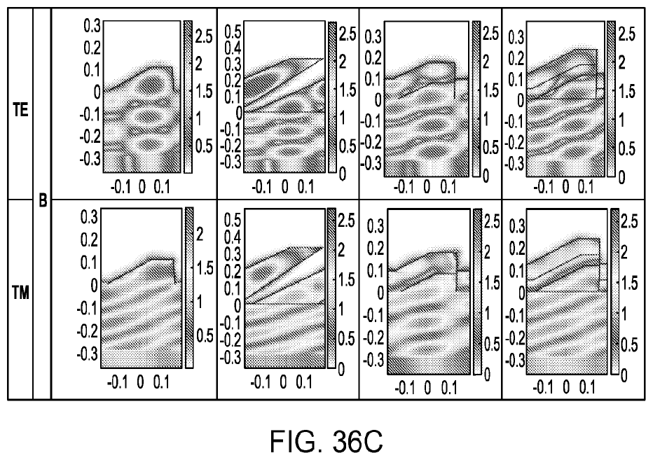

Referring to FIGS. 36A-36C, electric field magnitude is plotted within a unit cell of each of the grating structures specified in Tables 5, 6, 8, and 9. In particular, column A corresponds to plots for the structure in Table 5, column B corresponds to plots for the structure in Table 6, column C corresponds to plots for the structure of Table 8, and column D corresponds to plots for the structure of Table 9. The plots shown in FIG. 36A are made for light at the red wavelength (625 nm). The plots shown in FIG. 36B are made for light at the green wavelength (545 nm). The plots shown in FIG. 36C are made for light at the blue wavelength (465 nm). In each of these figures, the first row is the TE field, and the second row is the TM field. In each plot, the x-axis is the lateral dimension (x) and the y-axis is the vertical dimension (z). Units along both axes are microns. Notably, for the structure of Table 9 (column D), confinement of the electric field to the TiO2 layer is apparent, especially for TE red light.

Accordingly, it is believed that a two layer dielectric coating in which the refractive index of the first dielectric layer is higher than the refractive index of the ridges and the refractive index of the second dielectric layer can be advantageous due to a waveguiding-like confinement that can occur in this layer. It is believed that this confinement can modify the wavefront in the direction of the first diffraction order for both TE and TM polarizations.

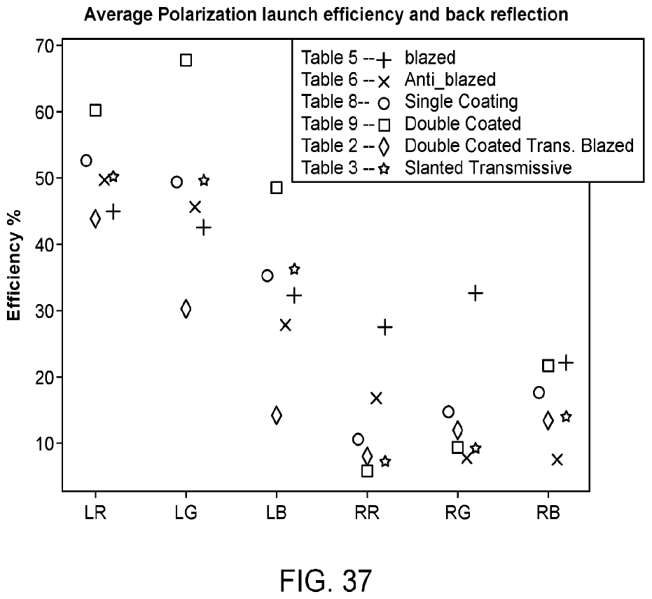

Referring to FIG. 37, launch efficiency and back reflection at each wavelength is summarized in a plot for each of the structures summarized in Tables 3-6 and 8-9. The y-axis shows an average diffraction efficiency (both for launch and back reflection) as a percentage. The x-axis includes 6 points. The first three points are the launch efficiency for R. G, and B, respectively. The last three points are back reflection efficiency for R, G, and B, respectively.

Generally, a variety of materials can be used for the dielectric layers including those materials listed above. Refractive index for these materials can vary from 1.5 up to 4.0. Example materials include MgF2, SiN2, SiO2, Al2O3, TiO2, and SiN.

### Further Examples

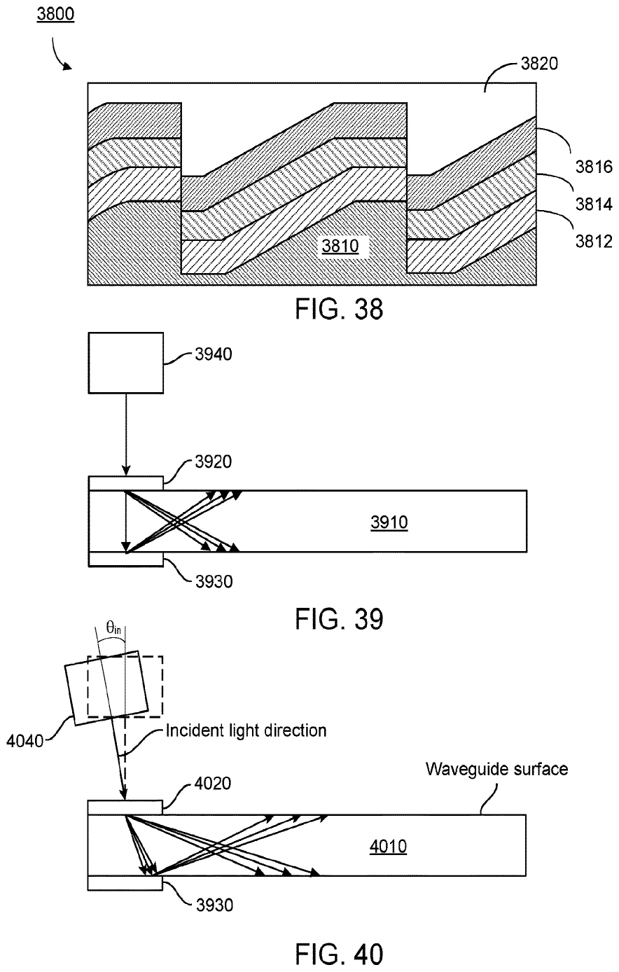

Other variations are also possible. For example, while the examples discussed above feature either zero, one, or two dielectric layers coating the grating layer, additional layers are possible. For example, additional layers can be included between the grating layer and the outermost low index layer. An example structure 3800 is shown in FIG. 38, which shows a grating structure with ridges 3810 that includes three dielectric layers 3812, 3814, and 3816 between the grating's ridges 3810 and a metal layer 3820. In some examples, n1<n2 and n3<n2, where n1 is the refractive index of coating 1, n2 is the refractive index of coating 2, and n3 is the refractive index of coating 3.

Although the performance of the example grating structures described above is determined at a single red wavelength, a single green wavelength, and a single blue wavelength, performance can be determined at other wavelengths (e.g., C, M, Y wavelengths). In general, performance can be determined and optimized at any combination of operative wavelengths.

Furthermore, while the foregoing example grating structures are one-dimensional gratings, other implementations are possible. For example, in some embodiments, an array of structures can also be arranged in two directions to form a two-dimensional (2D) array of diffractive features. The 2D array of diffractive features can include undulations in two directions. In some instances, the undulations can be periodic, while in other instances, the pitch of the undulations can vary in at least one direction. According to various examples described herein, the diffractive features have opposing sidewalls that are asymmetrically angled or tilted. According to various examples described herein, the diffractive features may be tapered.

In some implementations, the diffractive features can have opposing sidewalls that are substantially angled or tilted. In some implementations, the opposing sidewalls may be tilted in the same direction, while in other implementations, the opposing sidewalls may be tilted in opposite directions. In some other implementations, the diffractive features can have one of the opposing sidewalls that is substantially tilted, while having the other of the sidewalls that is substantially vertical or orthogonal to the horizontal axis or is at least tilted less than the other sidewall. In various examples of 2D diffractive features described herein, the 2D diffractive features can be formed in or on the underlying substrate, which can be a waveguide, as described above for various examples of 1D diffractive features. For example, the 2D diffractive features can be etched into the underlying substrate or be formed by patterning a separate layer formed thereon. Thus, the 2D diffractive features can be formed of the same or different material as the material of the substrate, in a similar manner as described above for various 2D diffractive features. Other variations and configurations are possible.

Accordingly, any of the structures or devices described herein such as grating structures may include a 1D grating. Similarly, any of the structures or devices described herein such as grating structures may comprise a 2D grating. Such 2D gratings may spread the light. These gratings may also comprise blazed gratings. Such blazed gratings may preferentially direct light in certain directions. In some implementations, the 2D gratings (e.g., having one tilted facet on the diffractive features) preferentially direct light in one direction while in others the 2D grating (e.g., having two tilted facets on the diffractive features differently) preferentially direct light into a plurality of directions Likewise, any of the methods or processes described herein can be used for 1D gratings. Similarly, any of the methods or processes described herein can be used for 2D gratings. These gratings, 1D or 2D, may be included in or on a substrate and/or waveguide and may be included in an eyepiece and possibly integrated into a head-mounted display as disclosed herein. These gratings may be employed as input gratings (e.g., ICGs), output gratings (EPEs), light distribution gratings (OPEs) or combined light distribution gratings/output gratings (e.g., CPEs). Examples of output coupling gratings are shown in FIGS. 9C and 10A, for example. Alternatively, or additionally, such gratings can be used in orthogonal pupil expanders (e.g., 730, 740, 750 in FIG. 9C). Such geometries can be optimized similarly for polarization insensitive output couplers and improve the display's transparency in the region in front of the user's eye, reducing back reflections which can be an issue for diffractive surface relief gratings when used as wearable waveguides.

In some examples, a waveguide can include two ICGs on opposing sides of a waveguide. For example, referring to FIG. 39, a waveguide 3910 includes a transmission ICG 3920 on the side of the waveguide facing a projector 3940 and a reflection ICG 3930 on the opposite side. The structure of the two ICGs can be optimized together to achieve low back reflection and high launch efficiency using structures described in the examples above. Both the transmission ICG 3920 and the reflection ICG 3930 launch light from the projector 3940 into the waveguide 3910.

As depicted in FIG. 39, the projector 3940 is arranged relative to the waveguide 3910 so that light from the projector 3940 is incident on the transmission mode ICG 3920 at an incident angle substantially normal to the surface of the waveguide 3910. However, in other examples, the projector can be arranged so that its light is non-normally incident on the waveguide. Such an arrangement is depicted in FIG. 40, wherein a projector 4040 is arranged so that the light is incident on a transmission ICG 4020 at an angle, θᵢₙ, that is not normal to the top surface of a waveguide 4010. In such arrangements, the incident angle, θᵢₙ, can be in a range from about 10 to 200 (measured from the normal of the waveguide surface) (e.g., in a range from about 3° to 15°, about 5° to 12°, about 5° to 10°).

Other embodiments are in the following claims.

1. A head-mounted display system comprising:
a head-mountable frame;
a light projection system configured to output light to provide image content;
a waveguide supported by the frame, the waveguide configured to guide at least a portion of the light from the light projection system coupled into the waveguide;
a grating structure optically coupled to the waveguide, the grating structure being configured to couple light from the light projection system into the waveguide, the grating structure comprising:
a grating layer comprising a plurality of ridges having a blaze profile in at least one cross-section; and
one or more dielectric layers disposed on the grating layer,
wherein, for unpolarized incident light at at least one operative wavelength of the output light, the grating structure has a mean launch efficiency of 40% or more and a mean back reflection of 15% or less over a field of view of 10° or more in at least one direction.

2. The head mounted display system of claim 1, wherein, for unpolarized incident light at at least two operative wavelengths of the output light at least 100 nm apart, the grating structure has a mean launch efficiency of 40% or more and a mean back reflection of 15% or less over a field of view of 10° or more in at least one direction.

3. The head mounted display system of claim 2, wherein, for unpolarized incident light at three operative wavelengths of the output light spanning a spectral range of 120 nm or more, the grating structure has a mean launch efficiency of 40% or more and a mean back reflection of 15% or less over a field of view of 10° or more in at least one direction.

4. The head mounted display system of claim 3, wherein the three wavelengths are a blue wavelength, a green wavelength, and a red wavelength.

5-7. (canceled)

8. The head mounted display system of claim 1, wherein the grating structure is a reflection grating structure.

9. The head mounted display system of claim 1, wherein the grating structure is a transmission grating structure.

10. (canceled)

11. The head mounted display system of claim 1, wherein the grating structure further comprises a metal layer disposed on the one or more dielectric layers.

12. The head mounted display system of claim 1, wherein the one or more dielectric layers comprise at least one continuous layer.

13. The head mounted display system of claim 1, wherein the one or more dielectric layers comprise at least one discontinuous layer.

14. The head mounted display system of claim 1, wherein the one or more dielectric layers comprises a first dielectric layer disposed directly on the grating layer and a second dielectric layer disposed directly on the first dielectric layer, the first dielectric layer have a larger refractive index at the operative wavelength than a refractive index of the grating layer and a refractive index of the second dielectric layer.

15. The head mounted display system of claim 1, wherein the one or more dielectric layers comprise a layer having a thickness in a range from 1 nm to 150 nm.

16-21. (canceled)

22. The head mounted display system of claim 1, wherein the launch efficiency of the grating structure corresponds to a first order diffraction efficiency of the grating structure.

23. The head mounted display system of claim 1, wherein the grating structure is a first grating structure and the system further comprises a second grating structure on an opposite side of the waveguide form the first grating structure.

24. The head mounted display system of claim 23, wherein the first grating structure is a reflection grating structure and the second grating structure is a transmission grating structure.

25. The head mounted display system of claim 23, wherein the second grating structure comprises a grating layer comprising a plurality of ridges and at least one dielectric layer supported by the grating layer.

26-30. (canceled)

31. The head-mounted display system of claim 1, wherein the grating structure comprises a cross-linked polymer that has a refractive index in a range from 1.5 to 2.25.

32. The head-mounted display system claim 1, wherein the waveguide supports a film of a material and the ridges are etched into the film.

33-36. (canceled)

37. The head-mounted display system of claim 32, wherein the material has a refractive index lower than a refractive index of the waveguide.

38-40. (canceled)

41. The head-mounted display of claim 1, wherein the grating layer and the waveguide are composed of the same material that comprises a polymer, and the material has a refractive index of 1.75 or less.

42-52. (canceled)

53. An article, comprising:
a waveguide layer;
a grating structure optically coupled to the waveguide, the grating structure being configured to couple light from a light projection system into the waveguide, the grating structure comprising:
a grating layer comprising a plurality of ridges having a blaze profile in at least one cross-section; and
one or more dielectric layers disposed on the grating layer,
wherein, for unpolarized incident light at at least one operative wavelength of the output light, the grating structure has a mean launch efficiency of 40% or more and a mean back reflection of 15% or less over a field of view of 10° or more in at least one direction.
